(19) United States
(12) Patent Application Publication
(10) Pub. No.: US 2026/0046725 A1
(43) Pub. Date: Feb. 12, 2026

(54) METHOD BY WHICH BASE STATION QUICKLY PROVIDES SLICE DESIRED BY TERMINAL IN NEXT-GENERATION MOBILE COMMUNICATION SYSTEM, AND DEVICE THEREFOR

(71) Applicant: Samsung Electronics Co., Ltd., Suwon-si, Gyeonggi-do (KR)

(72) Inventors: Sangyeob JUNG, Suwon-si (KR); Anil AGIWAL, Suwon-si (KR)

(21) Appl. No.: 19/102,991

(22) PCT Filed: Aug. 28, 2023
(86) PCT No.: PCT/KR2023/012710

§ 371 Date: Feb. 11, 2025

(30) Foreign Application Priority Data
Sep. 8, 2022 (KR) 10-2022-0114278

(51) Int. Cl. H04W 36/00; H04W 76/20; H04W 76/30

(52) U.S. Cl. CPC H04W 36/13; H04W 36/0058; H04W 76/20; H04W 76/30

(57) ABSTRACT

The present disclosure relates to a 5G or 6G communication system for supporting higher data transmission rates. The present disclosure relates to a method performed by a terminal in a wireless communication system, and a device for performing same, wherein the method comprises the steps of: storing measurement information obtained through slice-based cell reselection in a radio resource control (RRC) standby state or RRC inactive state; transmitting the measurement information obtained through the slice-based cell reselection to a base station after the terminal switches to an RRC connected state; and receiving, from the base station, information for configuring a cell supporting a slice for the terminal on the basis of the measurement information obtained through the slice-based cell reselection.

### TECHNICAL FIELD

The disclosure relates to an operation of a terminal and a base station of a mobile communication system. Further, the disclosure relates to a method and device for quickly providing a slice in a next generation mobile communication system.

### BACKGROUND ART

5G mobile communication technology defines a wide frequency band to enable a fast transmission speed and new services, and may be implemented not only in a frequency (‘sub 6 GHz’) band of 6 GHz or less such as 3.5 GHZ, but also in an ultra high frequency band (‘above 6 GHz’) called a mmWave such as 28 GHz and 39 GHz. Further, in the case of 6G mobile communication technology, which is referred to as a beyond 5G system, in order to achieve a transmission speed that is 50 times faster than that of 5G mobile communication technology and ultra-low latency reduced to 1/10 compared to that of 5G mobile communication technology, implementations in terahertz bands (e.g., such as 95 GHz to 3 terahertz (3 THz) band) are being considered.

In the early days of 5G mobile communication technology, with the goal of satisfying the service support and performance requirements for an enhanced mobile broadband (eMBB), ultra-reliable low-latency communications (URLLC), and massive machine-type communications (mMTC), standardization has been carried out for beamforming and massive multi-input multi-output (MIMO) for mitigating a path loss of radio waves in an ultra-high frequency band and increasing a propagation distance of radio waves, support for various numerologies (multiple subcarrier spacing operation, and the like) for efficient use of ultra-high frequency resources and dynamic operation for slot formats, initial access technology for supporting multi-beam transmission and broadband, a definition and operation of a band-width part (BWP), a new channel coding method such as low density parity check (LDPC) code for large capacity data transmission and polar code for high reliable transmission of control information, L2 pre-processing, and network slicing that provides a dedicated network specialized for specific services.

Currently, discussions are ongoing to improve initial 5G mobile communication technology and enhance a performance thereof in consideration of services in which 5G mobile communication technology was intended to support, and physical layer standardization for technologies such as vehicle-to-everything (V2X) for helping driving determination of an autonomous vehicle and increasing user convenience based on a location and status information of the vehicle transmitted by the vehicle, new radio unlicensed (NR-U) for the purpose of a system operation that meets various regulatory requirements in unlicensed bands, NR UE power saving, a non-terrestrial network (NTN), which is direct UE-satellite communication for securing coverage in regions where communication with a terrestrial network is impossible, and positioning is in progress.

Further, standardization in the field of air interface architecture/protocol for technologies such as industrial Internet of things (IIoT) for supporting new services through linkage and convergence with other industries, integrated access and backhaul (IAB) that provides nodes for expanding network service regions by integrating wireless backhaul links and access links, mobility enhancement including conditional handover and dual active protocol stack (DAPS) handover, and 2-step RACH for NR that simplifies a random access procedure is also in progress, and standardization in the field of system architecture/service for 5G baseline architecture (e.g., service based architecture, service based interface) for applying network functions virtualization (NFV) and software-defined networking (SDN) technologies, mobile edge computing (MEC) that receives services based on a location of a UE, and the like is also in progress.

When such a 5G mobile communication system is commercialized, connected devices in an explosive increase trend will be connected to communication networks; thus, it is expected that function and performance enhancement of a 5G mobile communication system and integrated operation of connected devices will be required. To this end, new research on extended reality (XR) for efficiently supporting augmented reality (AR), virtual reality (VR), mixed reality (MR), and the like, 5G performance improvement and complexity reduction using artificial intelligence (AI) and machine learning (ML), AI service support, metaverse service support, and drone communication will be conducted.

Further, the development of such a 5G mobile communication system will be the basis for the development of full duplex technology for improving frequency efficiency and system network of 6G mobile communication technology, satellite, artificial intelligence (AI)-based communication technology that utilizes AI from a design stage and that realizes system optimization by internalizing end-to-end AI support functions, and next generation distributed computing technology that realizes complex services beyond the limits of UE computing capabilities by utilizing ultra-high performance communication and computing resources as well as a new waveform for ensuring coverage in a terahertz band of 6G mobile communication technology, full dimensional MIMO (FD-MIMO), multi-antenna transmission technologies such as an array antenna and large scale antenna, metamaterial-based lenses and antennas for improving coverage of terahertz band signals, high-dimensional spatial multiplexing technology using orbital angular momentum (OAM), and reconfigurable intelligent surface (RIS) technology.

### DISCLOSURE

### Technical Problem

A technical problem to be achieved in various embodiments of the disclosure is to improve a performance of a terminal and a base station in a next generation mobile communication system. Further, a technical problem to be achieved in various embodiments of the disclosure is to provide a method and device for quickly providing a slice in a next generation mobile communication system.

### Technical Solution

According to the disclosure for solving the above problems, a method performed by a terminal in a wireless communication system includes storing measurement information acquired through slice-based cell reselection in a radio resource control (RRC) idle state or an RRC inactive state; transmitting, to a base station, measurement information acquired through the slice-based cell reselection after the terminal is switched to an RRC connected state; and receiving, from the base station, information for configuring a cell supporting a slice for the terminal based on measurement information acquired through the slice-based cell reselection.

Further, according to the disclosure, a method performed by a base station in a wireless communication system includes broadcasting system information including a capability to retrieve measurement information acquired through slice-based cell reselection; receiving measurement information through the slice-based cell reselection from a terminal converted from a radio resource control (RRC) idle state or an RRC inactive state to an RRC connected state; and transmitting, to the terminal, information for configuring a cell supporting a slice for the terminal based on measurement information acquired through the slice-based cell reselection.

Further, according to the disclosure, a terminal of a wireless communication system includes a transceiver; and a controller, wherein the controller is configured to control to store measurement information acquired through slice-based cell reselection in a radio resource control (RRC) idle state or an RRC inactive state, to transmit, to a base station, measurement information acquired through the slice-based cell reselection after the terminal is switched to an RRC connected state, and to receive, from the base station, information for configuring a cell supporting a slice for the terminal based on measurement information acquired through the slice-based cell reselection.

Further, according to the disclosure, a base station of a wireless communication system includes a transceiver; and a controller, wherein the controller is configured to control to broadcast system information including a capability to retrieve measurement information acquired through slice-based cell reselection, to receive measurement information through the slice-based cell reselection from a terminal converted from a radio resource control (RRC) idle state or an RRC inactive state to an RRC connected state, and to transmit, to the terminal, information for configuring a cell supporting a slice for the terminal based on measurement information acquired through the slice-based cell reselection.

Technical problems to be achieved in embodiments of the disclosure are not limited to the above-described technical problems, and other technical problems not described will be clearly understood by those of ordinary skill in the art to which the disclosure belongs from the description below.

### Advantageous Effects

According to various embodiments of the disclosure, a method and device for quickly providing a slice in a next generation mobile communication system can be provided.

### DESCRIPTION OF DRAWINGS

FIG. 1 is a diagram illustrating a structure of an LTE system according to an embodiment of the disclosure.

FIG. 2 is a diagram illustrating a wireless protocol structure in an LTE system according to an embodiment of the disclosure.

FIG. 3 is a diagram illustrating a structure of a next generation mobile communication system according to an embodiment of the disclosure.

FIG. 4 is a diagram illustrating a wireless protocol structure of a next generation mobile communication system according to an embodiment of the disclosure.

FIG. 5 is a message flow diagram illustrating a process in which a terminal receives a configuration of a slice group priority from a slice group through an access and mobility management function (AMF) in a next generation mobile communication system according to an embodiment of the disclosure.

FIG. 6 is a message flow diagram illustrating a terminal supporting slice-based cell reselection performing a slice-based cell reselection procedure in a next generation mobile communication system according to an embodiment of the disclosure.

FIG. 7 is a message flow diagram illustrating a method for a terminal to quickly receive a configuration of an intended slice from a base station in a next generation mobile communication system according to an embodiment of the disclosure.

FIG. 8 is a message flow diagram illustrating a method for a terminal to report intended slice information to a base station in a next generation mobile communication system according to an embodiment of the disclosure.

FIG. 9 is message flow diagram illustrating a method for a terminal to quickly receive a configuration of an intended slice from a base station in a next generation mobile communication system according to an embodiment of the disclosure.

FIG. 10 is a message flow diagram illustrating a method for a terminal to quickly receive a configuration of an intended slice from a base station in a next generation mobile communication system according to an embodiment of the disclosure.

FIG. 11 is a block diagram illustrating a constitution of a terminal according to an embodiment of the disclosure.

FIG. 12 is a block diagram illustrating a constitution of a base station according to an embodiment of the disclosure.

### MODE FOR DISCLOSURE

Hereinafter, preferred embodiments of the disclosure will be described in detail with reference to the accompanying drawings. In this case, it should be noted that in the accompanying drawings, the same components are denoted by the same reference numerals if possible. Further, detailed descriptions of well-known functions and constitutions that may obscure the gist of the disclosure will be omitted.

In describing embodiments in this specification, descriptions of technical contents that are well known in the technical field to which the disclosure pertains and that are not directly related to the disclosure will be omitted. This is to more clearly convey the gist of the disclosure without obscuring the gist of the disclosure by omitting unnecessary description.

For the same reason, some components are exaggerated, omitted, or schematically illustrated in the accompanying drawings. Further, the size of each component does not fully reflect the actual size. In each drawing, the same reference numerals are given to the same or corresponding components.

Advantages and features of the disclosure, and a method of achieving them will become apparent with reference to the embodiments described below in detail in conjunction with the accompanying drawings. However, the disclosure is not limited to the embodiments disclosed below, but may be implemented in various different forms, and only embodiments of the disclosure enable the disclosure to be complete, and are provided to fully inform the scope of the disclosure to those of ordinary skill in the art to which the disclosure belongs, and the disclosure is only defined by the scope of the claims. Like reference numerals refer to like components throughout the specification.

In this case, it will be understood that each block of message flow diagrams and combinations of the message flow diagrams may be performed by computer program instructions. Because these computer program instructions may be mounted in a processor of a general purpose computer, special purpose computer, or other programmable data processing equipment, the instructions performed by a processor of a computer or other programmable data processing equipment generate a means that performs functions described in the message flow diagram block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the message flow diagram block(s). Because the computer program instructions may be mounted on a computer or other programmable data processing equipment, a series of operation steps are performed on the computer or other programmable data processing equipment to generate a computer-executable process; thus, instructions for performing the computer or other programmable data processing equipment may provide steps for performing functions described in the message flow diagram block(s).

Further, each block may represent a portion of a module, a segment, or a code including one or more executable instructions for executing a specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

In this case, the term ‘-unit’ used in this embodiment means software or hardware components such as field programmable gate array (FPGA) or application specific integrated circuit (ASIC), and ‘-unit’ performs certain roles. However, ‘-unit’ is not limited to software or hardware. ‘-unit’ may be constituted to reside in an addressable storage medium or may be constituted to reproduce one or more processors. Therefore, as an example, ‘-unit’ includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and ‘-units’ may be combined into a smaller number of components and ‘-units’ or may be further separated into additional components and ‘-units’. Further, components and ‘-units’ may be implemented to reproduce one or more CPUs in a device or secure multimedia card.

Hereinafter, a base station is a subject performing resource allocation of a terminal, and may be at least one of a node B, a base station (BS), an eNode B, a gNode B, a radio access unit, a base station controller, or a node on a network. The terminal may include a user equipment (UE), a mobile station (MS), a cellular phone, a smart phone, a computer, or a multimedia system capable of performing a communication function. Further, the embodiments of the disclosure may be applied to other communication systems having a similar technical background or channel form to the embodiments of the disclosure described below. Further, the embodiments of the disclosure may be applied to other communication systems through some modifications within a range that does not significantly deviate from the scope of the disclosure by determination of a person having skilled technical knowledge. For example, 5G mobile communication technology (5G, new radio (NR)) developed after LTE-A may be included therein, and the following 5G may be a concept including existing LTE, LTE-A and other similar services. Further, the disclosure may be applied to other communication systems through some modifications within a range that does not significantly deviate from the scope of the disclosure by determination of a person having skilled technical knowledge.

Hereinafter, a term for identifying an access node, a term referring to a network entity or a network function (NF), a term referring to messages, a term referring to an interface between network objects, and terms referring to various identification information used in the description are exemplified for convenience of description. Accordingly, the disclosure is not limited to the terms described below, and other terms referring to an object having an equivalent technical meaning may be used.

Hereinafter, for convenience of description, some terms and names defined in the 3rd generation partnership project long term evolution (3GPP) standard and 3GPP new radio (NR) standard may be used. However, the disclosure is not limited by the above terms and names, and may be equally applied to systems conforming to other standards.

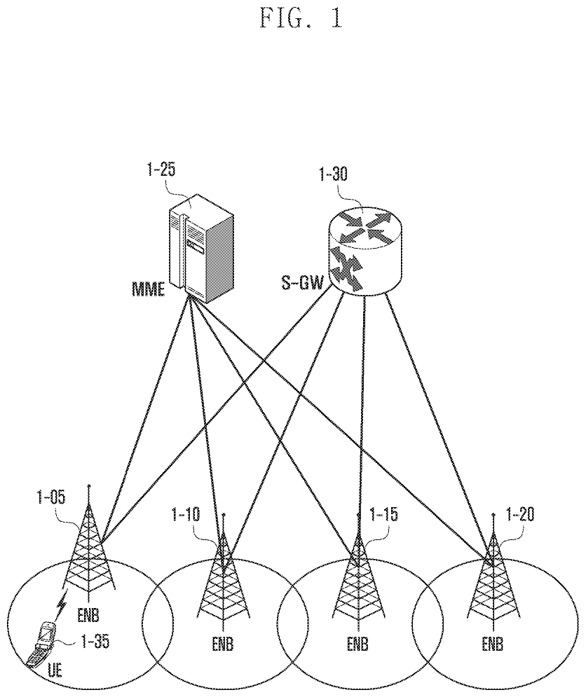

FIG. 1 is a diagram illustrating a structure of an LTE system according to an embodiment of the disclosure.

With reference to FIG. 1, as illustrated, a wireless access network of the LTE system is composed of evolved node Bs (hereinafter, ENBs, Node Bs, or base stations) 1-05, 1-10, 1-15, and 1-20, a mobility management entity (MME) 1-25, and a serving-gateway (S-GW) 1-30. A user equipment (hereinafter, UE or terminal) 1-35 accesses an external network through the ENBs 1-05 to 1-20 and the S-GW 1-30.

In FIG. 1, the ENBs 1-05, 1-10, 1-15, and 1-20 correspond to existing node Bs of an UMTS system. The ENB 1-05 is connected to the UE 1-35 through a wireless channel and performs a more complex role than that of the existing node B. In the LTE system, because all user traffic including real-time services such as a voice over IP (VOIP) through an Internet protocol is serviced through a shared channel, a device for collecting and scheduling status information such as a buffer status, available transmission power status, and channel status of UEs is required, and this is handled by the ENBs 1-05, 1-10, 1-15, and 1-20. One ENB usually controls multiple cells. For example, in order to implement a transmission speed of 100 Mbps, the LTE system uses, for example, orthogonal frequency division multiplexing (hereinafter, referred to as OFDM) as wireless access technology in a 20 MHz bandwidth. Further, an adaptive modulation and coding (hereinafter, referred to as AMC) method of determining a modulation scheme and a channel coding rate according to the channel status of the UE is applied. The S-GW 1-30 is a device that provides a data bearer and creates or removes a data bearer according to the control of the MME 1-25. The MME 1-25 is a device responsible for various control functions as well as a mobility management function for the UE 1-35 and is connected to a plurality of base stations 1-05, 1-10, 1-15, and 1-20.

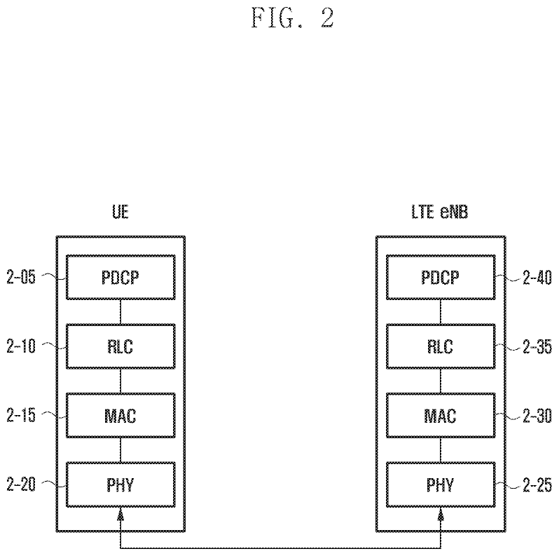

FIG. 2 is a diagram illustrating a wireless protocol structure in an LTE system according to an embodiment of the disclosure.

With reference to FIG. 2, a wireless protocol of the LTE system is composed of packet data convergence protocols (PDCPs) 2-05 and 2-40, radio link controls (RLCs) 2-10 and 2-35, and medium access controls (MACs) 2-15 and 2-30 in the UE and ENB, respectively. The PDCPs 2-05 and 2-40 are responsible for operations such as IP header compression/restoration. Main functions of the PDCP are summarized as follows.
Header compression and decompression: ROHC only
Transfer of user data
In-sequence delivery of upper layer PDUs at PDCP re-establishment procedure for RLC AM
For split bearers in DC (only support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink.

The radio link controls (hereinafter, referred to as RLCs) 2-10 and 2-35 reconfigure a PDCP packet data unit (PDU) to an appropriate size and perform ARQ operations. Main functions of the RLC are summarized as follows.
Transfer of upper layer PDUs
Error correction through ARQ (only for AM data transfer)
Concatenation, segmentation and reassembly of RLC SDUs (only for UM and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MACs 2-15 and 2-30 are connected to several RLC layer devices constituted in one UE, and perform operations of multiplexing RLC PDUs to MAC PDUs and demultiplexing RLC PDUs from MAC PDUs. Main functions of the MAC are summarized as follows.
Mapping between logical channels and transport channels
Multiplexing/demultiplexing of MAC SDUs belonging to one or different logical channels into and from transport blocks (TB) delivered to and from the physical layer on transport channels
Scheduling information reporting
Error correction through HARQ
Priority handling between logical channels of one UE
Priority handling between UEs by means of dynamic scheduling
MBMS service identification
Transport format selection
Padding

Physical layers 2-20 and 2-25 perform operations of channel-coding and modulating upper layer data, making the upper layer data into OFDM symbols and transmitting the OFDM symbols through a radio channel, or demodulating and channel-decoding OFDM symbols received through a radio channel and transmitting the OFDM symbols to the upper layer.

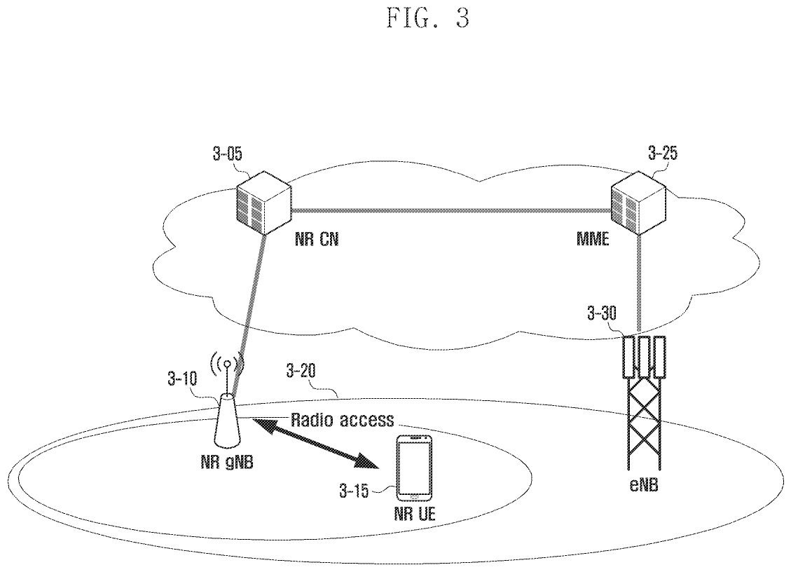

FIG. 3 is a diagram illustrating a structure of a next generation mobile communication system according to an embodiment of the disclosure.

With reference to FIG. 3, as illustrated, a wireless access network of a next generation mobile communication system (hereinafter, NR or 2 g) is composed of a new radio node B (hereinafter, NR gNB or NR base station) 3-10 and a new radio core network (NR CN) 3-05. A new radio user equipment (hereinafter, NR UE or terminal) 3-15 accesses an external network through the NR gNB 3-10 and the NR CN 3-05.

In FIG. 3, the NR gNB 3-10 corresponds to an evolved node B (eNB) of the existing LTE system. The NR gNB may be connected to the NR UE 3-15 through a radio channel and provide a superior service to that of the existing node B. In the NR, because all user traffic is serviced through a shared channel, a device for collecting and scheduling status information such as a buffer status, available transmission power status, and channel status of UEs is required, and this is handled by the NR gNB 3-10. One NR gNB 3-10 usually controls multiple cells. In order to implement ultrahigh speed data transmission compared to the current LTE, the NR may have a bandwidth higher than the existing maximum bandwidth, and beamforming technology may be additionally applied using orthogonal frequency division multiplexing (hereinafter, referred to as OFDM) as radio access technology. Further, an adaptive modulation & coding (hereinafter, referred to as AMC) scheme of determining a modulation scheme and a channel coding rate according to a channel status of the UE is applied. The NR CN 3-05 performs functions such as the mobility support, a bearer configuration, and a quality of service (QoS) configuration. The NR CN 3-05 is a device in charge of various control functions as well as a mobility management function for the UE, and is connected to a plurality of base stations. Further, the NR may be interworked with the existing LTE system, and the NR CN 3-05 is connected to an MME 3-25 through a network interface. The MME 3-25 is connected to an eNB 3-30, which is an existing base station.

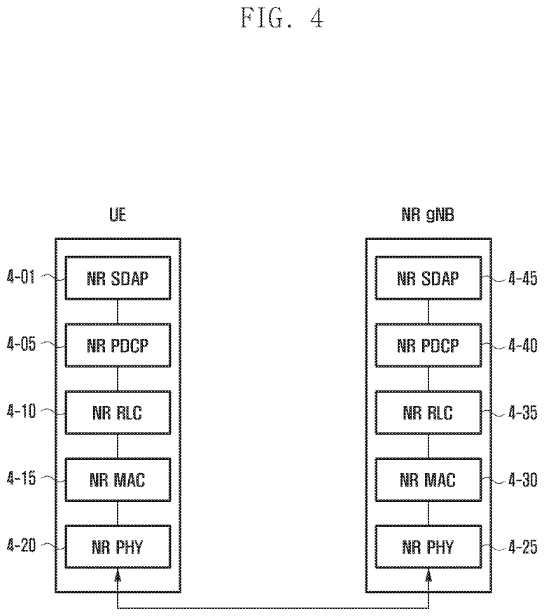

FIG. 4 is a diagram illustrating a wireless protocol structure of a next generation mobile communication system according to an embodiment of the disclosure.

FIG. 4 is a diagram illustrating a wireless protocol structure of a next generation mobile communication system to which the disclosure may be applied.

With reference to FIG. 4, a wireless protocol of the NR is composed of NR SDAPs 4-01 and 4-45, NR PDCPs 4-05 and 4-40, NR RLCs 4-10 and 4-35, and NR MACs 4-15 and 4-30 in the UE and the NR base station, respectively.

Main functions of the NR SDAPs 4-01 and 4-45 may include some of the following functions.
transfer of user plane data
mapping between a QoS flow and a DRB for both DL and UL
marking QoS flow ID in both DL and UL packets
reflective QoS flow to DRB mapping for the UL SDAP PDUs.

For the SDAP layer device, the UE may receive a configuration on whether to use a header of the SDAP layer device or to use a function of the SDAP layer device for each PDCP layer device, for each bearer, or for each logical channel with a radio resource control (RRC) message, and in the case that the SDAP header is configured, the UE may instruct to update or reconfigure mapping information on uplink and downlink QoS flows and data bearers using a non-access stratum (NAS) QoS reflection configuration 1-bit indicator (NAS reflective QoS) of the SDAP header and an access stratum (AS) QoS reflection configuration 1 bit indicator (AS reflective QoS). The SDAP header may include QoS flow ID information indicating a QoS. The QoS information may be used as a data processing priority and scheduling information for supporting a smooth service.

Main functions of the NR PDCPs 4-05 and 4-40 may include some of the following functions.

Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink.

In the above description, reordering of the NR PDCP device may mean reordering PDCP PDUs received from a lower layer based on a PDCP sequence number (SN), and include a function of delivering data to a higher layer in the rearranged order, a function of directly delivering data without considering the order, a function of recording lost PDCP PDUs by rearranging the order, a function of reporting a status of lost PDCP PDUs to the transmitting side, and a function of requesting retransmission of lost PDCP PDUs.

Main functions of the NR RLCs 4-10 and 4-35 may include some of the following functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

In the above description, in-sequence delivery of the NR RLC device may mean a function of sequentially delivering RLC SDUs received from a lower layer to a higher layer, and include a function of reassembling and delivering several RLC SDUs in the case that an original RLC SDU is divided into several RLC SDUs and received, a function of rearranging received RLC PDUs based on an RLC sequence number (SN) or a PDCP SN, a function of rearranging the order of RLC PDUs and recording lost RLC PDUs, a function of reporting a status of lost RLC PDUs to the transmitting side, a function of requesting retransmission of lost RLC PDUs, a function of sequentially delivering, in the case that there is a lost RLC SDU, only RLC SDUs before the lost RLC SDU to a higher layer or a function of sequentially delivering all RLC SDUs received before the timer starts to the higher layer, when a predetermined timer has expired even if there is a lost RLC SDU, or a function of sequentially delivering all RLC SDUs received so far to the higher layer, when a predetermined timer has expired even if there is a lost RLC SDU. Further, in the above description, the NR RLC device may process the RLC PDUs in the order of reception (regardless of order of serial numbers and sequence numbers, in order of arrival) and transfer the RLC PDUs to the PDCP device regardless of order (out-of sequence delivery), and in the case of a segment, the NR RLC device may receive segments stored in a buffer or to be received later, reconstitute segments into one complete RLC PDU and process, and then transfer the one complete RLC PDU to the PDCP device. The NR RLC layer may not include a concatenation function, and the concatenation function may be performed in the NR RLC layer or may be replaced with a multiplexing function of the NR MAC layer.

In the above description, out-of-sequence delivery of the NR RLC device may mean a function of directly delivering RLC SDUs received from a lower layer to a higher layer regardless of order, and include a function of reassembling and delivering several RLC SDUs in the case that an original RLC SDU is divided into several RLC SDUs and received and a function of storing RLC SNs or PDCP sequence numbers (SNs) of received RLC PDUs, arranging the order thereof, and recording lost RLC PDUs.

The NR MACs 4-15 and 4-30 may be connected to several NR RLC layer devices constituted in one UE, and main functions of the NR MAC may include some of the following functions.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

NR PHY layers 4-20 and 4-25 may perform operations of channel-coding and modulating higher layer data, making the higher layer data into OFDM symbols and transmitting the OFDM symbols through a radio channel, or demodulating OFDM symbols received through a radio channel, channel-decoding the OFDM symbols, and delivering the OFDM symbols to a higher layer.

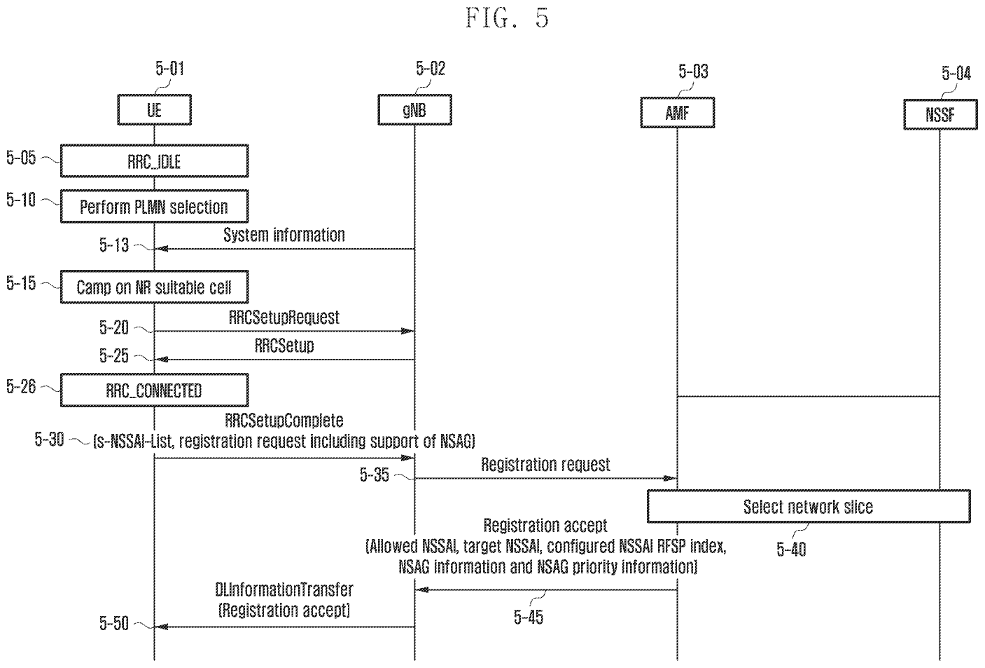

FIG. 5 is a message flow diagram illustrating a process in which a UE receives a configuration of a slice group priority from a slice group through an access and mobility management function (AMF) in a next generation mobile communication system according to an embodiment of the disclosure.

A slice group according to the disclosure may be composed of one or multiple slices. The slice group may be referred to as a network slice AS group (NSAG). A UE supporting an NSAG may receive a configuration of NSAG information and a priority value for each NSAG with an NAS message through an AMF, but the disclosure is not limited thereto. The NSAG information may be configured for each tracking area (hereinafter, TA), but the disclosure is not limited thereto. The NSAG information may include at least one of an NSAG identifier (NSAG-Id) for identifying each NSAG, mapping information on which NSAG a specific slice belongs to, or a tracking area identity (hereinafter, TAI) for each NSAG. For reference, in the case that the same NSAG identifier is used for each TA but that the same NSAG identifier are composed of different slices, a TAI may be included in the NSAG. That is, in the case that a TAI is not included in a specific NSAG, it may be indicated that mapping of the same slice(s) is applied to all TAs belonging to a registration area (hereinafter, RA) of the UE.

With reference to FIG. 5, a UE 5-01 may be in an RRC idle mode (RRC_IDLE) (5-05).

At step 5-10, the UE 5-01 in the RRC idle mode may perform a public land mobile network (PLMN) selection process.

At step 5-13, the UE 5-01 in the RRC idle mode acquires system information broadcasted by an NR gNB 5-02. At step 5-15, the UE 5-01 may camp on an NR suitable cell through a cell selection or cell reselection process based on the acquired system information.

The UE 5-01 in the RRC idle mode may perform an RRC connection establishment procedure with a camped-on cell. Specifically, at step 5-20, the UE 5-01 may transmit an RRC setup request message (RRCSetupRequest) to the NR gNB 5-02. At step 5-25, the NR gNB 5-02 may transmit an RRC setup message to the UE 5-01. The UE 5-01 that has received the RRC setup message may apply setup information stored in the RRC setup message and be switched (5-26) to the RRC connected mode (RRC_CONNECTED).

At step 5-30, the UE 5-01 switched to the RRC connected mode may transmit an RRC setup completion message to the NR gNB 5-02. In the case that an upper layer device provides one or multiple single network slice selection assistance information (S-NSSAI), the UE 5-01 may include an S-NSSAI-List in an RRC setup completion message with values provided by the upper layer device and transmit the RRC setup completion message to the NR gNB 5-02. The S-NSSAI-List is composed of one or multiple S-NSSAI, and each S-NSSAI may be composed of a slice/service type (SST) or an SST and slice/service type and slice differentiator (SST-SD), and an ASN. 1 structure is as follows.

### -S-NSSAI

The IE S-NSSAI (Single Network Slice Selection Assistance Information) identifies a Network Slice end to end and comprises a slice/service type and a slice differentiator, see TS 23.003 [21].

### S-NSSAI Information Element

| -- ASN1START | |
|---|---|
| -- TAG-S-NSSAI-START | |
| S-NSSAI ::= | CHOICE{ |
| sst | BIT STRING (SIZE (8)), |
| sst-SD | BIT STRING (SIZE (32)) |

}
-- TAG-S-NSSAI-STOP
-- ASN1STOP

S-NSSAI field descriptions

sst
Indicates the S-NSSAI consisting of Slice/Service Type, see TS 23.003 [21].
sst-SD
Indicates the S-NSSAI consisting of Slice/Service Type and Slice Differentiator, see TS 23.003 [21].

At step 5-30, the UE 5-01 may store a NAS message (DedicatedNAS-Message) in the RRC setup completion message and transmit the RRC setup completion message to the NR gNB 5-02. For example, the NAS message may mean a registration request message, but the disclosure is not limited thereto. The NAS message may include information indicating whether to support an NSAG.

At step 5-35, the NR gNB 5-02 may forward a registration request message to an AMF 5-03.

At step 5-40, a network slicing selection function (NSSF) 5-04 may select a network slice that may be supported by a 5G core and transmit the network slice to the AMF 5-03.

At step 5-45, the AMF 5-03 may store at least one of NSAG information on one or multiple N-SSAI or NSAG priority information in a registration accept message and transmit the registration accept message to the NR gNB 5-02. The NSAG information may include at least one of the following:
Mapping information on which NSAG one or multiple slices belong to and an identifier for each NSAG (NSAG-Id).
Maximum 32 NSAGs may be constituted for each PLMN, and the NSAG(s) may be unique for each PLMN.
The above information may be constituted for each TA.
Tracking area identity (hereinafter, TAI) or TA

For reference, the NSAG information and NSAG priority information may be provided in a UE configuration command message. At step 5-45, the AMF 5-03 may store an unsupportable (target NSSAI) among NSSAI requested by the UE 5-01 in the registration accept message and transmit it to the NR gNB 5-02. The message may also store an index to RAT/frequency slice selection priority (hereinafter, RFSP index).

At step 5-50, the NR gNB 5-02 may transmit a DLInformation Transfer message to the UE 5-01. The registration accept message may be stored in the message.

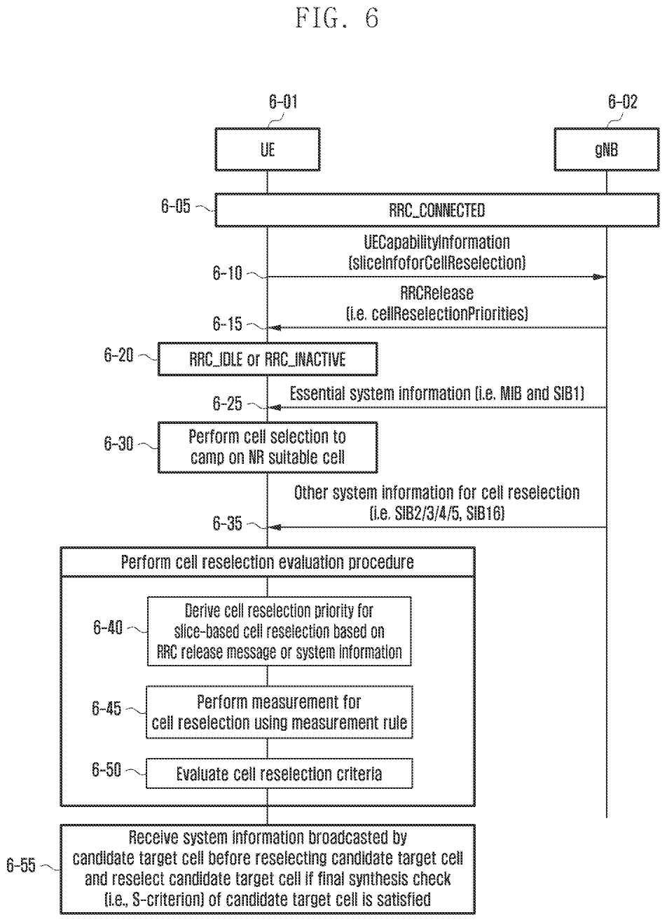

FIG. 6 is a message flow diagram illustrating a UE supporting slice-based cell reselection performing a slice-based cell reselection procedure in a next generation mobile communication system according to an embodiment of the disclosure.

A UE according to the disclosure may support slice-based cell reselection in a camped normally state (in the case of being camped on a suitable cell). That is, the UE may perform a slice-based cell reselection procedure in consideration of one or multiple network slice AS groups (NSAGs) provided from a non-access stratum (NAS) and priorities for each NSAG.

With reference to FIG. 6, a UE 6-01 may establish an RRC connection with an NR gNB 6-02 to be in an RRC connected mode (RRC_CONNECTED) (6-05). For reference, in the UE 6-01, as described in the foregoing embodiment, NSAG information and priority information for each NSAG may be configured with NAS messages through an access and mobility management function (AMF).

At step 6-10, the UE 6-01 may transmit a UE capability information message (UECapabilityInformation) to the NR gNB 6-02. The message may include an indicator for slice-based cell reselection. For example, the indicator may be the following indicator (sliceInfoforCellReselection).

Indicator indicating whether the UE supports slice reselection information included in a system information block (hereinafter, SIB) and RRCRelease in order to perform slice-based cell reselection in an RRC idle mode (RRC_IDLE) and an RRC inactive mode (RRC_INACTIVE).

At step 6-15, the NR gNB 6-02 may transmit an RRC release message (RRCRelease) to the UE 6-01. The message may store cell reselection priority configuration information. The cell reselection priority configuration information may include at least one of the following:
Frequency priority list for EUTRA (freqPriorityListEUTRA)
FreqPriorityListEUTRA is composed of one or multiple FreqPriorityEUTRA and is a list that may be composed of FreqPriorityEUTRA of maxFreq (=8). Each FreqPriorityEUTRA may be composed of at least one of a reference radio frequency channel number value (ARFCN-ValueEUTRA) indicating a carrier frequency, a cell reselection priority value (CellReselectionPriority), or a cell reselection sub-priority value (cellReselectionSubPriority). For reference, the cell reselection priority value may be configured to one integer value from 0 to 7, and the cell reselection sub-priority value may be configured to one decimal value of 0.2, 0.4, 0.6, and 0.6. In the case that the cell reselection priority value and the cell reselection sub-priority value are configured at the same time for a specific carrier frequency, the UE may add the two values to derive a cell reselection priority value. In the case that only one of the cell reselection priority value and the cell reselection sub-priority value is configured for a specific carrier frequency, the UE may derive a cell reselection priority value with the configured value.
Frequency priority list for NR (freqPriorityListNR)
FreqPriorityListNR is composed of one or multiple FreqPriorityNR and is a list that may be composed FreqPriorityNR of maxFreq (=8) (according to UE capability). FreqPriorityListNR may be composed of at least one of a reference radio frequency channel number value (ARFCN-ValueNR) indicating a carrier frequency, a cell reselection priority value (CellReselectionPriority), or a cell reselection sub-priority value (cellReselectionSubPriority). The UE may derive a cell reselection priority value for each NR carrier frequency, as described above. In the disclosure, for convenience of description, cell reselection priority information included in the list may be referred to as conventional cell reselection priority information.
t320 timer value
The timer value may be configured to one of 5 minutes, 10 minutes, 20 minutes, 30 minutes, 60 minutes, 120 minutes, and 180 minutes. The timer value may be configured to another value. The UE may operate the T320 timer with the configured timer value and apply cell reselection priority configuration information received with the RRC release message to perform a cell reselection evaluation procedure. That is, the UE may apply cell reselection priority configuration information received with the RRC release message to perform a cell reselection evaluation procedure until the T320 timer expires or is stopped. If the timer value is not configured, the UE may apply cell reselection priority configuration information until the cell reselection priority configuration information received with the RRC release message is erased to perform a cell reselection evaluation procedure. For reference, in case that the UE applies cell reselection priority configuration information received with the RRC release message to perform a cell reselection evaluation procedure, the UE may ignore cell reselection priority configuration information broadcasted in system information. For reference, the T320 timer and the above-described contents may be commonly applied to conventional cell reselection priority information and slice cell reselection priority information.
Slicing dedicated frequency priority list (freqPriorityListDedicatedSlicing)
FreqPriorityListDedicatedSlicing is composed of one or multiple FreqPriorityDedicatedSlicing and is a list that may be composed of FreqPriorityDedicatedSlicing of maxFreq (=8) (according to UE capability). FreqPriorityDedicatedSlicing may be composed of at least one of a reference radio frequency channel number value (ARFCN-ValueNR) indicating a carrier frequency or a slice dedicated information list (SliceInfoListDedicated). SliceInfoListDedicated may be composed of at least one of network slice AS group (NSAG) identification information (NSAG-IdentityInfo), an NSAG cell reselection priority value (nsag-CellReselectionPriority), or an NSAG cell reselection sub-priority value (nsag-CellReselectionSubPriority). The NSAG cell reselection priority value may be configured to an integer value within the same range as that of the above-described cell reselection priority value, and the NSAG cell reselection sub-priority value may be configured to a decimal value within the same range as that of the above-described cell reselection sub-priority value. NSAG-IdentityInfo may be composed of at least one of an NSAG identifier (NSAG-ID) or a tracking area code (trackingAreaCode). For an NR carrier frequency included in each FreqPriorityDedicatedSlicing, a cell reselection priority value may be derived according to the method described above. In various embodiments of the disclosure, for convenience of description, cell reselection priority information included in the list may be referred to as slice cell reselection priority information.

At step 6-15, the NR gNB 6-02 may transmit an RRC release message to the UE 6-01 without simultaneously including conventional cell reselection priority information and slice cell reselection priority information for the same NR frequency.

At step 6-20, the UE 6-01 that has received RRCRelease may be switched to an RRC idle mode or RRC inactive mode. Specifically, in the case of receiving RRCRelease including suspension configuration information (suspendConfig), the UE may be switched to the RRC inactive mode, and if not, the UE may be switched to the RRC idle mode.

At step 6-25, the UE 6-01 in the RRC idle mode or RRC inactive mode may acquire essential system information. Essential system information may mean a master information block (MIB) and a system information block 1 (SIB1).

At step 6-30, the UE 6-01 in the RRC idle mode or RRC inactive mode may perform a cell selection procedure to camp on an NR suitable cell. A cell in which the UE 6-01 camps on may be referred to as a serving cell.

In the disclosure, in the case that conditions in Table 1 are fulfilled based on the 3GPP standard document “38.304: User Equipment (UE) procedures in Idle mode and RRC Inactive state”, it may be defined as a suitable cell.

TABLE 1
suitable cell:

For UE not operating in SNPN Access Mode, a cell is considered as suitable if the following conditions
are fulfilled:
The cell is part of either the selected PLMN or the registered PLMN or PLMN of the Equivalent
PLMN list, and for that PLMN either:
The PLMN-ID of that PLMN is broadcast by the cell with no associated CAG-IDs and CAG-only
indication in the UE for that PLMN (TS 23.501 [10]) is absent or false;
Allowed CAG list in the UE for that PLMN (TS 23.501 [10]) includes a CAG-ID broadcast by the cell
for that PLMN;
The cell selection criteria are fulfilled, see clause 5.2.3.2.
According to the latest information provided by NAS:
The cell is not barred, see clause 5.3.1;
The cell is part of at least one TA that is not part of the list of “Forbidden Tracking Areas for Roaming”
(TS 22.011 [18]), which belongs to a PLMN that fulfils the first bullet above.
For UE operating in SNPN Access Mode, a cell is considered as suitable if the following conditions are
fulfilled:
The cell is part of either the selected SNPN or the registered SNPN of the UE;
The cell selection criteria are fulfilled, see clause 5.2.3.2;
According to the latest information provided by NAS:
The cell is not barred, see clause 5.3.1;
The cell is part of at least one TA that is not part of the list of “Forbidden Tracking Areas for Roaming”
which belongs to either the selected SNPN or the registered SNPN of the UE.

For reference, the UE 6-01 may determine that cell selection criteria are fulfilled if Equation 1 is satisfied.

$$Srxlev > 0 AND Squal > 0 \qquad Equation 1$$

$$where$$

$$Srxlev = Qrxlevmeas - ( Qrxlevmin + Qrxlevminoffset ) - Pcompensation - Qoffsettemp ,$$

$$Squal = Qqualmeas - ( Qqualmin + Qqualminoffset ) - Qoffsettemp .$$

The definition of parameters used here refers to the 3GPP standard document “38.304: User Equipment (UE) procedures in Idle mode and RRC Inactive state”.

At step 6-35, the UE 6-01 in the RRC idle mode or RRC inactive mode may acquire system information (e.g., SIB2, SIB3, SIB4, SIB5, SIB16) containing cell reselection information from the serving cell 6-02 so as to perform a cell reselection evaluation procedure. SIB2 may include information/parameters commonly applied in case that the UE reselects NR intra-frequency, NR inter-frequency, and inter-RAT frequency cells, and NR intra-frequency cell reselection information excluding information related to NR intra-frequency neighboring cells. For example, SIB2 may include one cell reselection priority configuration information on a serving NR frequency (a frequency to which a currently camped-on cell belongs). The cell reselection priority configuration information may mean a cellReselectionPriority and a cellReselectionSubPriority. Specifically, cellReselectionPriority may store an integer value (e.g., one integer value from 0 to 7), and cellReselectionSubPriority may store a decimal value (e.g., one decimal value of 0.2, 0.4, 0.6, and 0.8). In the case that both the cellReselectionPriority and the cellReselectionSubPriority are signaled, the UE may add the two values to derive a cell reselection priority value. For reference, a larger cell reselection priority value means a higher priority. Specifically, cell reselection configuration information broadcasted in SIB2 may be as illustrated in Table 2.

TABLE 2

| | |
|---|---|
| SIB2 ::= | SEQUENCE |
| cellReselectioninfoCommon | SEQUENCE { |

| | | |
|---|---|---|
| nrofSS-BlocksToAverage | INTEGER (2..maxNrofSS-BlocksToAverage) | OPTIONAL, |

-- Need S

| | | |
|---|---|---|
| absThreshSS-BlocksConsolidation | ThresholdNR | OPTIONAL, |

-- Need S

| | | |
|---|---|---|
| rangeToBestCell | RangeToBestCell | OPTIONAL, |

-- Need R

| q-Hyst | ENUMERATED { |
|---|---|
| | dB0, dB1, dB2, dB3, dB4, dB5, dB6, dB8, dB10, |
| | dB12, dB14, dB16, dB18, dB20, dB22, dB24}, |
| speedStateReselectionPars | SEQUENCE { |
| mobilityStateParameters | MobilityStateParameters, |
| q-HysSF | SEQUENCE { |
| sf-Medium | ENUMERATED {dB-6, dB-4, dB-2, dB0}, |
| sf-High | ENUMERATED {dB-6, dB-4, dB-2, dB0) |

}

| | |
|---|---|
| } | OPTIONAL, |

```
-- Need R
  ...
  },
```

| | |
|---|---|
| cellReselectionServingFreqInfo | SEQUENCE { |

| | | |
|---|---|---|
| s-NonIntraSearchP | ReselectionThreshold | OPTIONAL, |

-- Need S

| | | |
|---|---|---|
| s-NonIntraSearchQ | ReselectionThresholdQ | OPTIONAL, |

-- Need S

| threshServingLowP | ReselectionThreshold, | |
|---|---|---|
| threshServingLowQ | ReselectionThresholdQ | OPTIONAL, |

-- Need R

| cellReselectionPriority | CellReselectionPriority, | |
|---|---|---|
| cellReselectionSubPriority | CellReselectionSubPriority | OPTIONAL, -- |

```
Need R
    ...
  },
```

| | |
|---|---|
| intraFreqCellReselectionInfo | SEQUENCE { |

| | |
|---|---|
| q-RxLevMin | Q-RxLevMin, |

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| s-IntraSearchP | ReselectionThreshold, | |
|---|---|---|
| s-IntraSearchQ | ReselectionThresholdQ | OPTIONAL, |

-- Need S

| t-ReselectionNR | T-Reselection, | |
|---|---|---|
| frequencyBandList | MultiFrequencyBandListNR-SIB | OPTIONAL, |

-- Need S

| | | |
|---|---|---|
| frequencyBandListSUL | MultiFrequencyBandListNR-SIB | OPTIONAL, |

-- Need R

| | |
|---|---|
| p-Max | P-Max |

OPTIONAL, -- Need S

| | |
|---|---|
| smtc | SSB-MTC |

OPTIONAL, -- Need S

| | | |
|---|---|---|
| ss-RSSI-Measurement | SS-RSSI-Measurement | OPTIONAL, |

-- Need R

| | | |
|---|---|---|
| ssb-ToMeasure | SSB-ToMeasure | OPTIONAL, |

-- Need S

| | |
|---|---|
| deriveSSB-IndexFromCell | BOOLEAN, |

```
    ...,
    [[
```

| | | |
|---|---|---|
| t-ReselectionNR-SF | SpeedStateScaleFactors | OPTIONAL |

```
-- Need N
    ]],
    [[
```

| | | |
|---|---|---|
| smtc2-LP-r16 | SSB-MTC2-LP-r16 | OPTIONAL, |

-- Need R

| | | |
|---|---|---|
| ssb-PositionQCL-Common-r16 | SSB-PositionQCL-Relation-r16 | OPTIONAL |

```
-- Cond SharedSpectrum
    ]]
  },
  ...,
  [[
```

| | |
|---|---|
| relaxedMeasurement-r16 | SEQUENCE { |

| lowMobilityEvaluation-r16 | SEQUENCE { |
|---|---|
| s-SearchDeltaP-r16 | ENUMERATED { |
| | dB3, dB6, dB9, dB12, dB15, |
| | spare3, spare2, spare1}, |
| t-SearchDeltaP-r16 | ENUMERATED { |
| | s5, s10, s20, s30, s60, s120, s180, |
| | s240, s300, spare7, spare6, spare5, |
| | spare4, spare3, spare2, spare1} |

| | |
|---|---|
| } | OPTIONAL, |

-- Need R

| cellEdgeEvaluation-r16 | SEQUENCE { | |
|---|---|---|
| s-SearchThresholdP-r16 | ReselectionThreshold, | |
| s-SearchThresholdQ-r16 | ReselectionThresholdQ | OPTIONAL |

-- Need R

| | |
|---|---|
| } | OPTIONAL, |

-- Need R

| | |
|---|---|
| combineRelaxedMeasCondition-r16 | ENUMERATED {true} |

OPTIONAL, -- Need R

| | | |
|---|---|---|
| highPriorityMeasRelax-r16 | ENUMERATED {true) | OPTIONAL |

-- Need R

| | |
|---|---|
| } | OPTIONAL |

-- Need R
]]
}
RangeToBestCell ::= Q-OffsetRange

SIB3 may include neighboring cell information/parameters for the UE to reselect an NR intra-frequency cell. For example, in SIB3, there may be broadcasted an NR intra-frequency cell list (intraFreqNeighCellList) for reselecting an NR intra-frequency cell or a cell list (intraFreqBlackCellList) in which NR intra-frequency cell reselection is not allowed. Specifically, in SIB3, information of Table 3 may be broadcasted.

TABLE 3

| | |
|---|---|
| SIB3 ::= | SEQUENCE { |

| | |
|---|---|
| intraFreqNeighCellList | IntraFreqNeighCellList |

OPTIONAL, -- Need R

| | |
|---|---|
| intraFreqBlackCellList | IntraFreqBlackCellList |

OPTIONAL, -- Need R

| | |
|---|---|
| lateNonCriticalExtension | OCTET STRING |

```
OPTIONAL,
  ...,
  [[
```

| | |
|---|---|
| intraFreqNeighCellList-v1610 | IntraFreqNeighCellList-v1610 |

OPTIONAL, -- Need R

| | |
|---|---|
| intraFreqWhiteCellList-r16 | IntraFreqWhiteCellList-r16 |

OPTIONAL, -- Cond SharedSpectrum2

| | |
|---|---|
| intraFreqCAG-CellList-r16 | SEQUENCE (SIZE (1..maxPLMN)) OF IntraFreqCAG-CellListPerPLMN-r16 |

OPTIONAL -- Need R
]]
}

| IntraFreqNeighCellList ::= | SEQUENCE (SIZE (1..maxCellIntra)) OF IntraFreqNeighCellInfo | |
|---|---|---|
| IntraFreqNeighCellList-v1610::= | SEQUENCE (SIZE (1..maxCellIntra)) OF IntraFreqNeighCellInfo-v1610 | |
| IntraFreqNeighCellInfo ::= | SEQUENCE { | |
| physCellId | PhysCellId, | |
| q-OffsetCell | Q-OffsetRange, | |
| q-RxLexMinOffsetCell | INTEGER (1..8) | OPTIONAL, -- |

Need R

| | | |
|---|---|---|
| q-RxLevMinOffsetCellSUL | INTEGER (1..8) | OPTIONAL, - |

- Need R

| | | |
|---|---|---|
| q-QualMinOffsetCell | INTEGER (1..8) | OPTIONAL, -- |

Need R
...
}

| IntraFreqNeighCellInfo-v1610 ::= | SEQUENCE { | |
|---|---|---|
| ssb-PositionQCL-r16 | SSB-PositionQCL-Relation-r16 | OPTIONAL -- |

Cond SharedSpectrum2
}

| | |
|---|---|
| IntraFreqBlackCellList ::= | SEQUENCE (SIZE (1..maxCellBlack)) OF PCI-Range |
| IntraFreqWhiteCellList-r16 ::= | SEQUENCE (SIZE (1..maxCellWhite)) OF PCI-Range |

IntraFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF PCI-Range |

}

SIB4 may include information/parameters for the UE to reselect an NR inter-frequency cell. For example, in SIB4 one or multiple NR inter-frequencies may be broadcasted, and one cell reselection priority configuration information for each NR inter-frequency may be broadcasted. Cell reselection priority configuration information for each NR inter-frequency means the above-described content (e.g., cellReselectionPriority and/or cellReselectionSubPriority mapped to each NR inter-frequency), but has the characteristic that one cell reselection priority configuration information for each inter-frequency is optionally broadcasted. Specifically, in SIB4, information in Table 4 may be broadcasted.

TABLE 4

| SIB4 ::= | SEQUENCE { | |
|---|---|---|
| interFreqCarrierFreqList | InterFreqCarrierFreqList, | |
| lateNonCriticalExtension | OCTET STRING | OPTIONAL, |

```
  ...,
  [[
```

| | | |
|---|---|---|
| interFreqCarrierFreqList-v1610 | InterFreqCarrierFreqList-v1610 | OPTIONAL -- Need R |

]]
}

| | |
|---|---|
| InterFreqCarrierFreqList ::= | SEQUENCE (SIZE (1..maxFreq)) OF InterFreqCarrierFreqInfo |
| InterFreqCarrierFreqList-v1610 ::= | SEQUENCE (SIZE (1..maxFreq)) OF InterFreqCarrierFreqInfo-v1610 |
| InterFreqCarrierFreqInfo ::= | SEQUENCE { |
| dl-CarrierFreq | ARFCN-ValueNR, |

| | |
|---|---|
| frequencyBandList | MultiFrequencyBandListNR-SIB |

OPTIONAL, -- Cond Mandatory

| | |
|---|---|
| frequencyBandListSUL | MultiFrequencyBandListNR-SIB |

OPTIONAL, -- Need R

| | |
|---|---|
| nrofSS-BlocksToAverage | INTEGER (2..maxNrofSS-BlocksToAverage) |

OPTIONAL, -- Need S

| | |
|---|---|
| absThreshSS-BlocksConsolidation | ThresholdNR |

OPTIONAL, -- Need S

| | |
|---|---|
| smtc | SSB-MTC |

OPTIONAL, -- Need S

| | |
|---|---|
| ssbSubcarrierSpacing | SubcarrierSpacing, |

| | |
|---|---|
| ssb-ToMeasure | SSB-ToMeasure |

OPTIONAL, -- Need S

| | |
|---|---|
| deriveSSB-IndexFromCell | BOOLEAN, |

| | |
|---|---|
| ss-RSSI-Measurement | SS-RSSI-Measurement |

OPTIONAL,

| | |
|---|---|
| q-RxLevMin | Q-RxLevMin, |

| | |
|---|---|
| q-RxLevMinSUL | Q-RxLevMin |

OPTIONAL, -- Need R

| | |
|---|---|
| q-Qualmin | Q-QualMin |

OPTIONAL, -- Need S

| | |
|---|---|
| p-Max | P-Max |

OPTIONAL, -- Need S

| | |
|---|---|
| t-ReselectionNR | T-Reselection, |

| | |
|---|---|
| t-ReselectionNR-SF | SpeedStateScaleFactors |

OPTIONAL, -- Need S

| | |
|---|---|
| threshX-HighP | ReselectionThreshold, |
| threshX-LowP | ReselectionThreshold, |
| threshX-Q | SEQUENCE { |
| threshX-HighQ | ReselectionThresholdQ, |
| threshX-LowQ | ReselectionThresholdQ |

}
OPTIONAL, -- Cond RSRQ

| | |
|---|---|
| cellReselectionPriority | CellReselectionPriority |

OPTIONAL, -- Need R

| | |
|---|---|
| cellReselectionSubPriority | CellReselectionSubPriority |

OPTIONAL, -- Need R

| | |
|---|---|
| q-OffsetFreq | Q-OffsetRange |

DEFAULT dB0,

| | |
|---|---|
| interFreqNeighCellList | InterFreqNeighCellList |

OPTIONAL, -- Need R

| | |
|---|---|
| interFreqBlackCellList | InterFreqBlackCellList |

OPTIONAL, -- Need R
...
}

| | |
|---|---|
| InterFreqCarrierFreqInfo-v1610 ::= | SEQUENCE { |

| | |
|---|---|
| interFreqNeighCellList-v1610 | InterFreqNeighCellList-v1610 |

OPTIONAL, -- Need R

| | |
|---|---|
| smtc2-LP-r16 | SSB-MTC2-LP-r16 |

OPTIONAL, -- Need R

| | |
|---|---|
| interFreqWhiteCellList-r16 | InterFreqWhiteCellList-r16 |

OPTIONAL, -- Cond SharedSpectrum2

| | |
|---|---|
| ssb-PositionQCL-Common-r16 | SSB-PositionQCL-Relation-r16 |

OPTIONAL, -- Cond SharedSpectrum

| | |
|---|---|
| interFreqCAG-CellList-r16 | SEQUENCE (SIZE (1..maxPLMN)) OF InterFreqCAG-CellListPerPLMN-r16 |

OPTIONAL -- Need R
}

| | |
|---|---|
| InterFreqNeighCellList ::= | SEQUENCE (SIZE (1..maxCellInter)) OF InterFreqNeighCellInfo |
| InterFreqNeighCellList-v1610 ::= | SEQUENCE (SIZE (1..maxCellInter)) OF InterFreqNeighCellInfo-v1610 |
| InterFreqNeighCellInfo ::= | SEQUENCE { |
| physCellId | PhysCellId, |
| q-OffsetCell | Q-OffsetRange, |

| | |
|---|---|
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| InterFreqNeighCellInfo-v1610 ::= | SEQUENCE { |

| | |
|---|---|
| ssb-PositionQCL-r16 | SSB-PositionQCL-Relation-r16 |

OPTIONAL -- Cond SharedSpectrum2
}

| | |
|---|---|
| InterFreqBlackCellList ::= | SEQUENCE (SIZE (1..maxCellBlack)) OF PCI-Range |
| InterFreqWhiteCellList-r16 ::= | SEQUENCE (SIZE (1..maxCellWhite)) OF PCI-Range |

InterFreqCAG-CellListPerPLMN-r16 ::= SEQUENCE {

| | |
|---|---|
| plmn-IdentityIndex-r16 | INTEGER (1..maxPLMIN), |
| cag-CellList-r16 | SEQUENCE (SIZE (1..maxCAG-Cell-r16) OF PCI-Range |

}

SIB5 may include information/parameters for the UE to reselect an inter-RAT frequency cell. For example, in SIB5, one or multiple EUTRA frequencies may be broadcasted, and one cell reselection priority configuration information for each EUTRA frequency may be broadcasted. Cell reselection priority configuration information for each EUTRA frequency means the above-described content (e.g., cellReselectionPriority and/or cellReselectionSubPriority mapped to each EUTRA frequency), but has the characteristic that one cell reselection priority configuration information for each EUTRA frequency is optionally broadcasted. Specifically, in SIB5, information in Table 5 may be broadcasted.

TABLE 5

| SIB5 ::= | SEQUENCE { | |
|---|---|---|
| carrierFreqListEUTRA | CarrierFreqListEUTRA | OPTIONAL, -- |

Need R

| t-ReselectionEUTRA | T-Reselection, | |
|---|---|---|
| t-ReselectionEUTRA-SF | SpeedStateScaleFactors | OPTIONAL, -- |

Need S

| | | |
|---|---|---|
| lateNonCriticalExtension | OCTET STRING | OPTIONAL, |

```
  ...,
  [[
```

| | | |
|---|---|---|
| carrierFreqListEUTRA-v1610 | CarrierFreqListEUTRA-v1610 | OPTIONAL -- |

Need R
]]
}

| CarrierFreqListEUTRA ::= | SEQUENCE (SIZE (1..maxEUTRA-Carrier)) OF CarrierFreqEUTRA | |
|---|---|---|
| CarrierFreqListEUTRA-v1610 ::= | SEQUENCE (SIZE (1..maxEUTRA-Carrier)) OF CarrierFreqEUTRA-v1610 | |
| CarrierFreqEUTRA ::= | SEQUENCE { | |
| carrierFreq | ARFCN-ValueEUTRA, | |
| eutra-multiBandInfoList | EUTRA-MultiBandinfoList | OPTIONAL, -- |

Need R

| | | |
|---|---|---|
| eutra-FreqNeighCellList | EUTRA-FreqNeighCellList | OPTIONAL, -- |

Need R

| | | |
|---|---|---|
| eutra-BlackCellList | EUTRA-FreqBlackCellList | OPTIONAL, -- |

Need R

| allowedMeasBandwidth | EUTRA-AllowedMeasBandwidth, | |
|---|---|---|
| presenceAntennaPort1 | EUTRA-PresenceAntennaPort1, | |
| cellReselectionPriority | CellReselectionPriority | OPTIONAL, -- Need R |
| cellReselectionSubPriority | CellReselectionSubPriority | OPTIONAL, -- Need R |

| | |
|---|---|
| threshX-High | ReselectionThreshold, |
| threshX-Low | ReselectionThreshold, |
| q-RxLevNin | INTEGER (−70..−22), |
| q-QualMin | INTEGER (−34..−3), |
| p-MaxEUTRA | INTEGER (−30..33), |
| threshX-Q | SEQUENCE { |
| threshX-HighQ | ReselectionThresholdQ, |
| threshX-LowQ | ReselectionThresholdQ |

| | |
|---|---|
| } | OPTIONAL - |

- Cond RSRQ
}
CarrierFreqEUTRA-v1610 ::= SEQUENCE {

| | | |
|---|---|---|
| highSpeedEUTRACarrier-r16 | ENUMERATED {true} | OPTIONAL |

-- Need R
}

| EUTRA-FreqBlackCellList ::= | SEQUENCE (SIZE (1..maxEUTRA-CellBlack)) OF EUTRA-PhysCellIdRange | |
|---|---|---|
| EUTRA-FreqNeighCellList ::= | SEQUENCE (SIZE (1..maxCellEUTRA)) OF EUTRA-FreqNeighCellinfo | |
| EUTRA-FreqNeighCellInfo ::= | SEQUENCE { | |
| physCellId | EUTRA-PhysCellId, | |
| dummy | EUTRA-Q-OffsetRange, | |
| q-RxLevMinOffsetCell | INTEGER (1..8) | OPTIONAL, -- |

Need R

| | | |
|---|---|---|
| q-QualMinOffsetCell | INTEGER (1..8) | OPTIONAL -- |

Need R
}

SIB16 may include information/parameters for the UE to perform slice-based cell reselection. For example, in SIB16, there may be broadcasted slice-based cell reselection priority information on NR frequencies in which the UE may perform slice-based cell reselection among NR frequencies broadcasted in SIB2 and SIB4. Specifically, a slice information list (SliceInfoList) for each NR frequency that may perform slice-based cell reselection may be broadcasted. SliceInfoList may be composed of one or multiple SliceInfo, and each SliceInfo may include at least one of nsag-IdentityInfo, nsag-CellReselectionPriority, nsag-CellReselectionSubPriority, or sliceCellList. Specifically, in SIB16, information in Table 6 may be broadcasted.

TABLE 6

| SIB16-r17 ::= | SEQUENCE { | |
|---|---|---|
| freqPriorityListSlicing-r17 | FreqPriorityListSlicing-r17 | OPTIONAL, -- Need R |
| lateNonCriticalExtension | OCTET STRING | OPTIONAL, |

...
}
FreqPriorityListSlicing-r17 ::= SEQUENCE (SIZE (1..maxFreqPlus1)) OF FreqPrioritySlicing-r17

| | |
|---|---|
| FreqPrioritySlicing-r17 ::= | SEQUENCE { |

| | |
|---|---|
| dl-ImplicitCarrierFreq-r17 | INTEGER (0..maxFreq), |

| | |
|---|---|
| sliceInfoList-117 | SliceInfoList-r17 |

OPTIONAL -- Need R
}

| | |
|---|---|
| SliceInfoList-r17 ::= | SEQUENCE (SIZE (1..maxSliceInfo-r17)) OF SliceInfo-r17 |
| SliceInfo-r17 ::= | SEQUENCE { |

| | |
|---|---|
| nsag-IdentityInfo-r17 | NSAG-IdentityInfo-r17, |

| | |
|---|---|
| nsag-CellReselectionPriority-r17 | CellReselectionPriority |

OPTIONAL, -- Need R

| | |
|---|---|
| nsag-CellReselectionSubPriority-r17 | CellReselectionSubPriority |

OPTIONAL, -- Need R

| | |
|---|---|
| sliceCellListNR-r17 | CHOICE { |

| | |
|---|---|
| sliceAllowedCellListNR-r17 | SliceCellListNR-r17, |
| sliceExcludedCellListNR-r17 | SliceCellListNR-r17 |

}
OPTIONAL -- Need R
}

| | |
|---|---|
| SliceCellListNR-r17 ::= | SEQUENCE (SIZE (1..maxCellSlice-r17)) OF PCI-Range |

FreqPrioritySlicing field descriptions
dl-ImplicitCarrierFreq
Indicates the downlink carrier frequency to which sliceInfoList is associated with. The frequency is signalled
implicitly, value 0 corresponds to the serving frequency, value 1 corresponds to the first frequency indicated by
the InterFreqCarrierFreqList in SIB4, and value 2 coresponds to the second frequency indicated by the
InterFreqCarrierFreqList in SIB4, and so on.
SliceInfo field descriptions
nsag-IdentityInfo
This is the NSAG identifier of the NSAG.
sliceAllowedCellListNR
List of allow-listed neighbouring cells for slicing. If present, cells not listed in this list do not support the corresponding nsag-frequency
pair, according to 38.304 [20], clause 5.2.4.11.
sliceCellListNR
Contains either the list of allow-listed or exclude-listed neighbour cells for slicing.
sliceExcludedCellListNR
List of exclude-listed neighbouring cells for slicing. If present, cells not listed in this list support the corresponding slice nsag-frequency
pair, according to 38.304 [20], clause 5.2.4.11.

In various embodiments of the disclosure, cell reselection priority information broadcasted in SIB2, SIB4, and SIB5 is conventional cell reselection priority information, and cell reselection priority information broadcasted in SIB16 may be referred to as slice cell reselection priority information.

At step 6-40, the UE 6-01 in the RRC idle mode or RRC inactive mode may derive a reselection priority for slice-based cell reselection. If cellReselectionPriorities are configured in an RRC release message, they may be applied to derive a reselection priority, as described above. That is, the reselection priority broadcasted in system information may be ignored. However, as described above, in the case that cellReselectionPriorities of the RRC release message are not applied, a reselection priority may be derived by applying reselection priority information broadcasted in system information. Specifically, the UE may derive a reselection priority according to the following rules.
Frequencies that support at least one prioritized NSAG received from the NAS have a higher re-selection priority than frequencies that support none of the NSAG(s) received from the NAS.
Frequencies that support at least one NSAG among NSAGs received from the NAS are prioritized according to the NSAG priority value provided by the NAS, and the NSAG priority value for each frequency means a highest NSAG priority value among NSAGs supported (received from the NAS) in the corresponding frequency. For example, in the case that a specific frequency supports NSAG 1 and NSAG 2, but that an NSAG 1 priority value (provided by the NAS) is 3 and that an NSAG 2 priority value is 1, the corresponding frequency may be prioritized according to the NSAG 1 priority value.
For (one or multiple) frequencies that support the highest prioritized one or multiple NSAG(s) with the same NAS priorities, the frequencies may be prioritized in the order of nsag-CellReselectionPrioriry and/or nsag-CellReselectionSubPriority. For example, in the case that a frequency 1 supports NSAG 1 (NSAG 1 priority value is 2) and that a frequency 2 supports NSAG 2 (NSAG 2 priority value is 2) and that an nsag-CellReselectionPriority for NSAG 1 in the frequency 1 is broadcasted as 3 and that an nsag-CellReselectionPriority for NSAG 2 in the frequency 2 is broadcasted as 2, the frequency 1 may be prioritized over the frequency 2. In the case that no nsag-CellReselectionPriority is given for the corresponding NSAG at the corresponding frequency, the UE may use the lowest (reselection) priority value.
Frequencies that support none of the NSAG(s) provided by the NAS may be prioritized according to conventional reselection priority information.

For reference, the UE may consider that the corresponding frequency supports all slices mapped to an NSAG if the following conditions are satisfied.
the nsag-ID and TA of the NSAG as provided by NAS are indicated for the NR frequency (see TS 38.331)

At step 6-45, the UE 6-01 in the RRC idle mode or RRC inactive mode may perform frequency measurement for cell reselection. In this case, the UE 6-01 may perform frequency measurement using the following measurement rule according to the cell reselection priority determined at step 6-40 in order to minimize battery consumption.
If the following condition 1 is satisfied, the UE may not perform NR intra-frequency measurement. Otherwise (e.g., in the case that the following condition 1 is not satisfied), the UE performs NR intra-frequency measurement.
Condition 1: A reception level (Srxlev) of the serving cell is greater than a SIntraSearchP threshold, and a reception quality (Squal) of the serving cell is greater than a SIntraSearchQ threshold (Serving cell fulfils Srxlev>SIntraSearchP and Squal>SIntraSearchQ).
For an NR inter-frequency or inter-RAT frequency having a higher reselection priority than that of the NR frequency of a current serving cell, the UE may perform measurement according to the 3GPP TS 38.133 standard.
For an NR inter-frequency having a reselection priority lower than or equal to that of the NR frequency of the current serving cell and an inter-RAT frequency having a reselection priority lower than that of the NR frequency of the current serving cell, the UE may not perform measurement if the following condition 2 is satisfied. Otherwise (e.g., in the case that the following condition 2 is not satisfied), the UE measures cells in an NR inter-frequency having a reselection priority lower than or equal to that of the NR frequency or measures cells in an inter-RAT frequency having a reselection priority lower than that of the NR frequency.
Condition 2: A reception level (Srxlev) of the serving cell is greater than a SnonIntraSearchP threshold and a reception quality (Squal) of the serving cell is greater than a SnonIntraSearchQ threshold (Serving cell fulfils Srxlev>SnonIntraSearchP and Squal>SnonIntraSearchQ).

For reference, the thresholds described above (SintraSearchP, SintraSearchQ, SnonIntraSearchP, SnonintraSearchQ) may be broadcasted in the system information acquired at step 1f-35.

At step 6-50, the UE 6-01 in the RRC idle mode or RRC inactive state may determine to reselect a cell satisfying cell reselection criteria based on the measurement value performed at step 6-45. Different cell reselection criteria may be applied according to the cell reselection priority. In the case that multiple cells satisfying cell reselection criteria have different cell reselection priorities, reselecting a frequency/RAT cell with a higher cell reselection priority shall be prioritized over reselecting a frequency/RAT cell with a lower cell reselection priority. Specifically, an operation of the UE with respect to the reselection criteria of an inter-frequency/inter-RAT cell having a higher priority than that of a frequency of the current serving cell is as follows.

First operation:
In the case that in SIB2, a threshold for threshServingLowQ is included and broadcasted, and that 1 second has passed after the UE camped on the current serving cell, if a signal quality (Squal) of an inter-frequency/inter-RAT cell is greater than the threshold ThreshX, HighQ during a specific time TreselectionRAT (Squal>ThreshX, HighQ during a time interval TreselectionRAT), the UE performs reselection to the corresponding inter-frequency/inter-RAT cell.

### Second Operation:

In the case that the UE may not perform the first operation, the UE performs the second operation.
If 1 second has passed after the UE camped on the current serving cell and a reception level (Srxlev) of an inter-frequency/inter-RAT cell is greater than a threshold ThreshX,HighP during a specific time TreselectionRAT (Srxlev>ThreshX, HighP during a time interval Treselection-RAT), the UE performs reselection to the corresponding inter-frequency/inter-RAT cell.

Here, the UE may perform the first or second operation using a signal quality (Squal), a reception level (Srxlev), thresholds (ThrehX, HighQ, ThreshX, HighP), and TreselectionRAT values of an inter-frequency cell based on information included in SIB4 broadcasted in the serving cell, and perform the first or second operation using a signal quality (Squal), a reception level (Srxlev), threshold (ThreshX,HighQ, ThreshX, HighP), and TreselectionRAT values of an inter-RAT cell based on information included in SIB5 broadcasted in the serving cell. For example, in SIB4, a Qqualmin value or Qrxlevmin value is included and a signal quality (Squal) or a reception level (Srxlev) of an inter-frequency cell is derived based on the value. In the case that there are multiple cells in the NR frequency satisfying a high cell reselection priority, the UE may reselect a highest ranked cell among cells satisfying reselection criteria of an intra-frequency/inter-frequency cell having the same priority as that of a frequency of the current serving cell described below.

Further, an operation of the UE with respect to reselection criteria of an intra-frequency/inter-frequency cell having the same priority as that of a frequency of the current serving cell is as follows.

### Third Operation:

In the case that a signal quality (Squal) and reception level (Srxlev) of an intra-frequency/inter-frequency cell are greater than 0, the UE derives a rank for each cell based on the measurement value (RSRP). Ranks of the serving cell and neighboring cells are each calculated using Equation 2.

$${R}_{s} = {Q}_{meas , s} + {Q}_{hyst} \qquad Equation 2$$

$${R}_{n} = {Q}_{meas , n} - Qoffset$$

Here, Qmeas,s is an RSRP measurement value of the serving cell, Qmeas,n is an RSRP measurement value of neighboring cells, Qhyst is a hysteresis value of the serving cell, and Qoffset is offset between the serving cell and the neighboring cells. A Qhyst value is included in SIB2, and the corresponding value is commonly used for reselection of an intra-frequency/inter-frequency cell. In the case of reselection of an intra-frequency cell, Qoffset is signaled for each cell, applied only to the indicated cell, and included in SIB3. In case of reselection of an inter-frequency cell, Qoffset is signaled for each cell, applied only to the indicated cell, and included in SIB4. In the case that a rank of the neighboring cell obtained from the Equation 2 is greater than that of the serving cell (Rn>Rs), an optimal cell among neighboring cells is reselected.

Further, an operation of the UE for reselection criteria of an inter-frequency/inter-RAT cell with a lower priority than that of a frequency of the current serving cell is as follows.

### Fourth Operation:

In the case that in SIB2, a threshold for threshServingLowQ is included and broadcasted and that 1 second has passed after the UE camped on a current serving cell, if a signal quality (Sqaul) of the current serving cell is smaller than the threshold ThreshServing, LowQ (Squal<ThreshServing, LowQ) and a signal quality (Squal) of an inter-frequency/inter-RAT cell is greater than the threshold ThreshX, LowQ (Squal>ThreshX, LowQ during a time interval TreselectionRAT) during a specific time TreselectionRAT, the UE performs reselection to the corresponding inter-frequency/inter-RAT cell.

### Fifth Operation:

In the case that the UE may not perform the fourth operation, the UE performs the fifth operation.
If 1 second has passed after the UE camped on the current serving cell, and a reception level (Srxlev) of the current serving cell is smaller than the threshold ThreshServing, LowP (Srxlev<ThreshServing, LowP) and a reception level (Srxlev) of an inter-frequency/inter-RAT cell is greater than the threshold ThreshX, LowQ (Srxlev>ThreshX,LowP during a time interval TreselectionRAT) during a specific time TreselectionRAT, the UE performs reselection to the corresponding inter-frequency/inter-RAT cell.

Here, the fourth or fifth operation for the inter-frequency cell of the UE is performed based on thresholds (ThreshServing, LowQ, ThreshServing, LowP) included in SIB2 broadcasted in the serving cell and a signal quality (Squal), reception level (Srxlev), thresholds (ThrehX, LowQ, ThreshX, LowP), and Treselection RAT of an inter-frequency cell included in SIB4 broadcasted in the serving cell, and the fourth or fifth operation for an inter-RAT cell of the UE is performed based on thresholds (ThreshServing, LowQ, ThreshServing, LowP) included in SIB2 broadcasted in the serving cell and a signal quality (Squal), reception level (Srxlev), thresholds (ThreshX,LowQ, ThreshX, LowP), and TreselectionRAT of the inter-RAT cell included in SIB5 broadcasted in the serving cell. For example, in SIB4, a Qqualmin value or Qrxlevmin value is included, and a signal quality (Squal) or a reception level (Srxlev) of the inter-frequency cell is derived based on the value. In the case that there are multiple cells in an NR frequency satisfying a high cell reselection priority, the UE may reselect a highest ranked cell among cells satisfying reselection criteria of an intra-frequency/inter-frequency cell having the same priority as that of a frequency of a current serving cell described below. In the case that the above conditions are satisfied and a single candidate cell is derived in a frequency with a higher or lower priority than that of a frequency of the current serving cell, the UE may reselect the best cell.

The UE performing slice-based cell reselection according to an embodiment of the disclosure may additionally determine whether the best cell or the highest ranked cell satisfying the cell reselection criteria described above at step 6-50 at a specific frequency supports the corresponding NSAG based on the NSAG derived at step 6-40 and the reselection priority for the frequency. Specifically, the UE 6-01 may consider that a cell in the corresponding frequency supports all slices mapped to an NSAG if the following conditions are satisfied.
the nsag-ID and TA of the NSAG as provided by NAS are indicated for the NR frequency (see TS 38.331) and
the cell is either listed in the sliceAllowedCellListNR (if provided in the used slice specific cell reselection information) or the cell is not listed in the sliceExcludedCellListNR (if provided in the used slice specific cell reselection information); or
Neither sliceAllowedCellListNR nor sliceExcludedCellListNR is configured in the used slice specific cell reselection information

In the case that the best cell or the highest ranked cell does not support the corresponding NSAG, the UE may derive a reselection priority through the following operations.
In the case that the best cell or the highest ranked cell supports other NSAG(s), the UE may re-derive a priority of a frequency to which the corresponding cell belongs by considering the NSAG(s) supported by the corresponding cell (rather than those of the corresponding NR frequency).
Otherwise (i.e., in the case that no other NSAG(s) is (are) supported by the corresponding cell), the UE may re-derive a reselection priority of the corresponding frequency as if none of the NSAG(s) provided by the NAS is supported at the frequency of the corresponding cell.

For reference, the re-derived reselection priority may be used for a maximum of 300 seconds, or until new information of NSAG(s) and their priorities are received from the NAS. The UE 6-01 may ensure that the cell reselection criteria above are fulfilled based on newly derived priorities.

At step 6-55, the UE 6-01 in the RRC idle mode or RRC inactive state receives system information (e.g., MIB or SIB1) broadcasted by a candidate target cell before finally reselecting the candidate target cell. The UE 6-01 determines whether a reception level (Srxlev) and a reception quality (Squal) of the candidate target cell satisfy a cell selection criterion called S-criterion (Equation 1) (Srxlev>0 AND Squal>0) based on the received system information. If Equation 1 is satisfied and the candidate target cell is suitable, the UE 6-01 may reselect the candidate target cell.

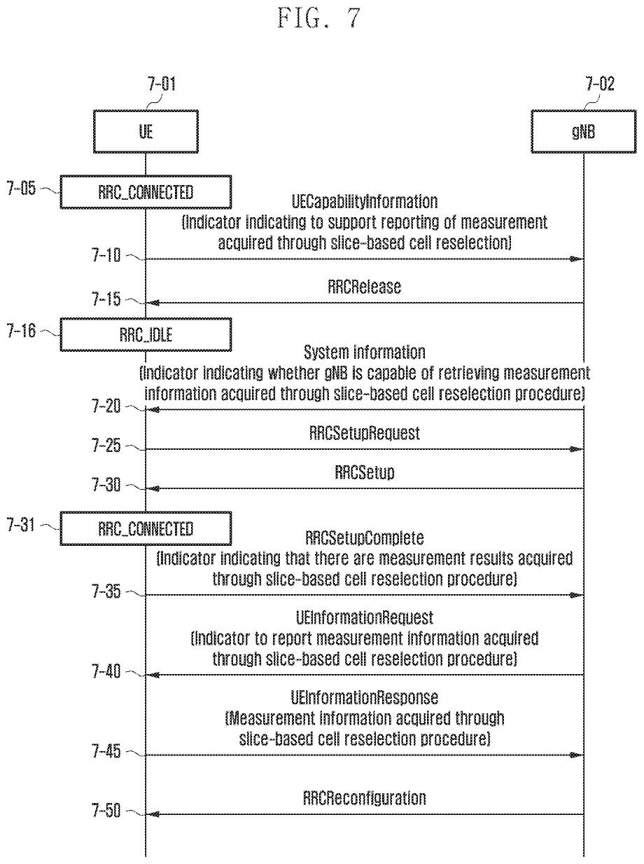

FIG. 7 is a message flow diagram illustrating a method for a UE to quickly receive a configuration of an intended slice from a base station in a next generation mobile communication system according to an embodiment of the disclosure.

With reference to FIG. 7, a UE 7-01 may establish an RRC connection with a base station 7-02 to be in an RRC connected mode (RRC_CONNECTED) (7-05).

At step 7-10, the UE 7-01 in the RRC connected mode may transmit a UE capability information message (UECapabilityInformation) to the base station 7-02. The message may include an indicator indicating that measurement information acquired through a slice-based reselection procedure may be transmitted to the base station 7-02.

At step 7-15, the base station 7-02 may transmit an RRC release message (RRCRelease) to the UE 7-01. The UE 7-01 may apply the received RRC release message and be switched (7-16) to the RRC idle mode (RRC_IDLE).

At step 7-20, the UE 7-01 in the RRC idle mode may acquire system information broadcasted by the base station 7-02. The base station transmitting the RRC release message at step 7-15 and the base station transmitting system information at step 7-20 may be the same base station or different base stations. The disclosure proposes to broadcast an indicator indicating whether the base station 7-02 is capable of retrieving measurement information acquired by the UE through a slice-based cell reselection procedure through system information. The UE 7-01 may perform a slice-based cell reselection procedure according to the foregoing embodiment.

The UE 7-01 in the RRC idle mode may perform an RRC connection establishment procedure with the base station 7-02. Specifically, the UE 7-01 may transmit (7-25) an RRC setup request message (RRCSetupRequest) to the base station 7-02, and in response thereto, the base station 7-02 may transmit (7-30) an RRC setup message (RRCSetup) to the UE 7-01. The UE 7-01 that has received the RRC setup message may be switched to the RRC connected mode (7-31).

At step 7-35, the UE 7-01 in the RRC connected mode may transmit an RRC setup complete message (RRCSetupComplete) to the base station 7-02. The message may include an indicator that there are measurement results acquired through a slice-based cell reselection procedure. For reference, the indicator may be included in only the case that a currently connected primary cell (PCell) does not support a slice or slice group in which the UE 7-01 intends to use. Alternatively, the message may include information on a slice group (NSAG) in which the UE 7-01 intends to use.

At step 7-40, the base station 7-02 may transmit a UE information request message (UEInformationRequest) to the UE 7-01. The message may include an indicator to report measurement information acquired by the UE 7-01 through a slice-based cell reselection procedure.

At step 7-45, the UE 7-01 may transmit a UE information response message (UEInformationResponse) to the base station 7-02. The message may store measurement information acquired by the UE 7-01 through a slice-based cell reselection procedure. The UE 7-01 may store the measurement information in only the case that a currently connected primary cell does not support a slice (or slice group) in which the UE 7-01 intends to use or may store only measurement information related to a slice (or slice group) in which the UE intends to use.

At step 7-50, the base station 7-02 may transmit an RRC reconfiguration message (RRCReconfiguration) to the UE 7-01. That is, the base station 7-02 may quickly configure carrier aggregation and/or dual connectivity to the UE using the RRC reconfiguration message based on the information received at step 7-45. That is, the base station 7-02 may quickly configure a slice in which the UE intends based on information acquired through slice-based cell reselection, and configure CA or DC so as to support a slice in which the UE intends.

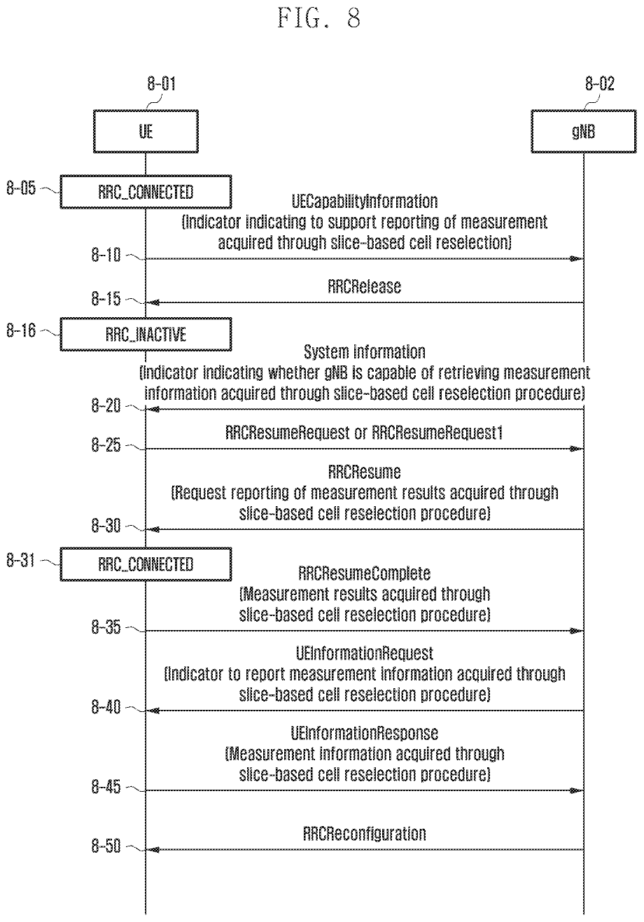

FIG. 8 is a message flow diagram illustrating a method for a UE to quickly receive a configuration of an intended slice from a base station in a next generation mobile communication system according to an embodiment of the disclosure.

With reference to FIG. 8, a UE 8-01 may establish an RRC connection with a base station 8-02 to be in an RRC connected mode (RRC_CONNECTED) (8-05).

At step 8-10, the UE 8-01 in the RRC connected mode may transmit a UE capability information message (UECapabilityInformation) to the base station 8-02. The message may include an indicator indicating that measurement information acquired through a slice-based reselection procedure may be transmitted to the base station.

At step 8-15, the base station 8-02 may transmit an RRC release message (RRCRelease) to the UE 8-01. The UE 8-01 may apply the received RRC release message and be switched (8-16) to the RRC inactive mode (RRC_INACTIVE).

At step 8-20, the UE 8-01 in the RRC inactive mode may acquire system information broadcasted by the base station 8-02. The base station transmitting the RRC release message at step 8-15 and the base station transmitting system information at step 8-20 may be the same base station or different base stations. The embodiment of the disclosure proposes to broadcast an indicator indicating whether the base station 8-02 is capable of retrieving measurement information acquired by the UE 8-01 through a slice-based cell reselection procedure through the system information. The UE 8-01 may perform a slice-based cell reselection procedure according to the foregoing embodiment.

The UE 8-01 in the RRC inactive mode may perform an RRC connection resume procedure with the base station 8-02. Specifically, the UE 8-01 transmits (8-25) an RRC resume request message (RRCResumeRequest or RRCResumeRequest 1) to the base station 8-02. In response thereto, the base station 8-02 may transmit (8-30) an RRC resume message (RRCResume) to the UE 8-01. The base station 8-02 may request the UE 8-01 to report measurement results acquired through a slice-based cell reselection procedure through the RRC resume message. The UE 8-01 that has received the RRC resume message may be switched to the RRC connected mode (8-31).

At step 8-35, the UE 8-01 in the RRC connected mode may transmit an RRC resume complete message (RRCResumeComplete) to the base station 8-02. In the case that the base station 8-02 requests the UE 8-01 to report measurement results acquired through the slice-based cell reselection procedure at step 8-30, the UE 8-01 may store the information in the RRC resume complete message. Otherwise, the UE 8-01 may include an indicator, in the message, that there are measurement results acquired through the slice-based cell reselection procedure. Alternatively, the message may include information on a slice group (NSAG) in which the UE 8-01 intends to use.

At step 8-40, the base station 8-02 may transmit a UE information request message (UEInformationRequest) to the UE 8-01. The message may include an indicator to report measurement information acquired by the UE through a slice-based cell reselection procedure.

At step 8-45, the UE 8-01 may transmit a UE information response message (UEInformationResponse) to the base station 8-02. The message may store measurement information acquired by the UE 8-01 through a slice-based cell reselection procedure. The UE 8-01 may store the measurement information in only the case that a currently connected primary cell does not support a slice (or slice group) in which the UE intends to use or may store only measurement information related to a slice (or slice group) in which the UE intends to use.

At step 8-50, the base station 8-02 may transmit an RRC reconfiguration message (RRCReconfiguration) to the UE 8-01. The base station 8-02 may quickly configure carrier aggregation and/or dual connectivity to the UE 8-01 through the RRC reconfiguration based on the information received at step 8-45.

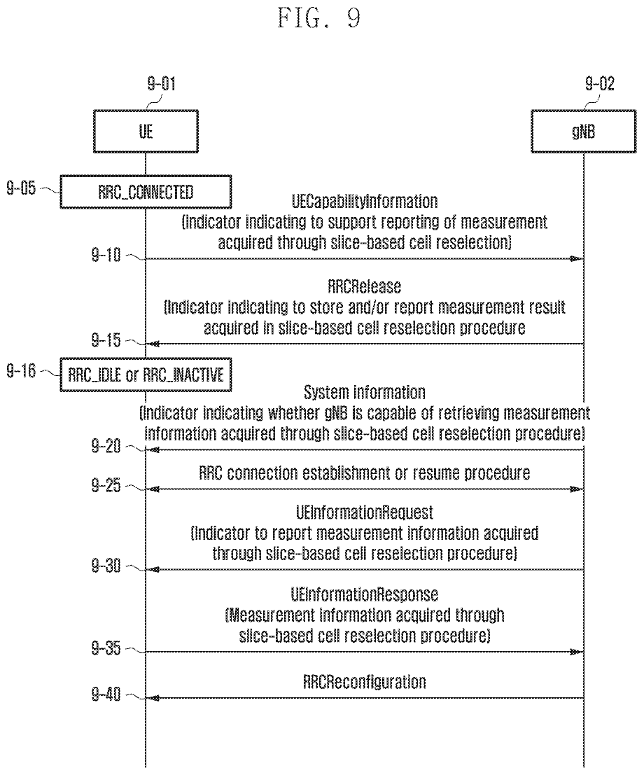

FIG. 9 is a message flow diagram illustrating a method for a UE to quickly receive a configuration of an intended slice from a base station in a next generation mobile communication system according to an embodiment of the disclosure.

With reference to FIG. 9, a UE 9-01 may establish an RRC connection with a base station 9-02 to be in an RRC connected mode (RRC_CONNECTED) (9-05).

At step 9-10, the UE 9-01 in the RRC connected mode may transmit a UE capability information message (UECapabilityInformation) to the base station 9-02. The message may include an indicator indicating that measurement information acquired through a slice-based reselection procedure may be transmitted to the base station.

At step 9-15, the base station 9-02 may transmit an RRC release message (RRCRelease) to the UE 9-01. The message may include an indicator to store and/or report measurement results acquired by the UE 9-01 in the slice-based cell reselection procedure in the RRC idle mode (RRC_IDLE) or the RRC inactive mode (RRC_INACTIVE). Alternatively, the message may configure a timer so as to store and/or report measurement results acquired by the UE 9-01 in the slice-based cell reselection procedure in the RRC idle mode (RRC_IDLE) or the RRC inactive mode (RRC_INACTIVE). That is, the UE 9-01 may store the corresponding measurement results while the timer is running. Alternatively, the message may include a validity area (one or multiple frequencies or a list of cells for each frequency) to enable the UE 9-01 to store measurement results only for the validity area. The UE 9-01 may apply the received RRC release message and be switched (9-16) to be switched to an RRC inactive mode (RRC_INACTIVE) or an RRC idle mode (RRC_IDLE).

At step 9-20, the UE 9-01 in the RRC inactive mode or RRC idle mode may acquire system information broadcasted by the base station 9-02. The base station transmitting the RRC release message at step 9-15 and the base station transmitting system information at step 9-20 may be the same base station or different base stations. The embodiment of the disclosure proposes to broadcast an indicator indicating that the base station 9-02 is capable of retrieving measurement information acquired by the UE 9-01 through a slice-based cell reselection procedure through system information. The UE 9-01 may perform a slice-based cell reselection procedure according to the foregoing embodiment.

The UE 9-01 in the RRC inactive mode or RRC idle mode may perform an RRC connection establishment procedure or an RRC connection resume procedure with the base station 9-02 (9-25). This may follow the foregoing embodiment.

At step 9-30, the base station 9-02 may transmit a UE information request message (UEInformationRequest) to the UE 9-01. The message may include an indicator to report measurement information acquired by the UE 9-01 through a slice-based cell reselection procedure.

At step 9-35, the UE 9-01 may transmit a UE information response message (UEInformationResponse) to the base station 9-02. The message may store measurement information acquired by the UE 9-01 through a slice-based cell reselection procedure. The UE 9-01 may store the measurement information in only the case that the currently connected primary cell does not support a slice (or slice group) in which the UE 9-01 intends to use or may store only measurement information related to a slice (or slice group) in which the UE intends to use.

At step 9-40, the base station 9-02 may transmit an RRC reconfiguration message (RRCReconfiguration) to the UE 9-01. Based on the information received at step 9-45, the base station 9-02 may quickly configure carrier aggregation and/or dual connectivity to the UE 9-01 through the RRC reconfiguration message.

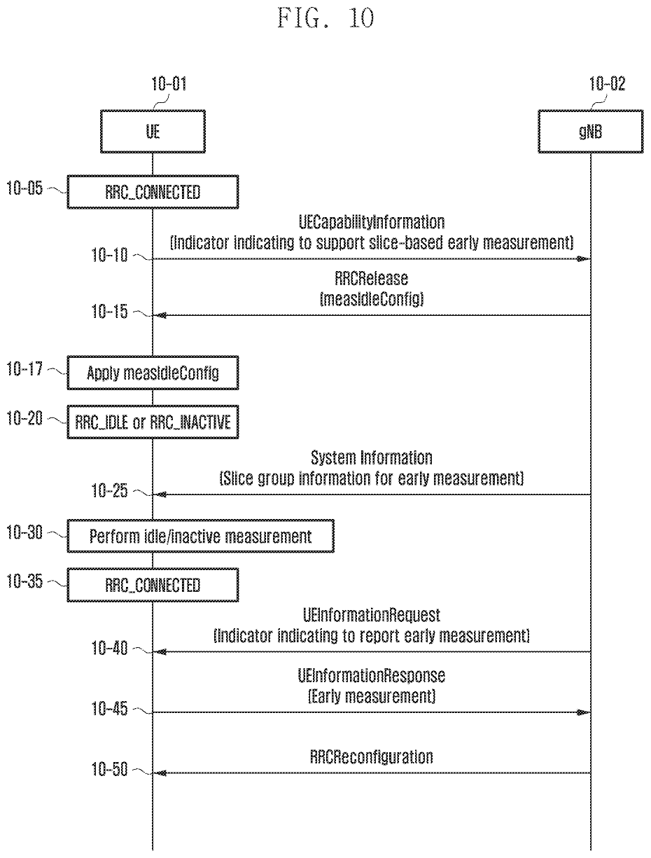

FIG. 10 is a message flow diagram illustrating a method for a UE to quickly receive a configuration of an intended slice from a base station in a next generation mobile communication system according to an embodiment of the disclosure.

With reference to FIG. 10, a UE 10-01 may establish an RRC connection with a base station 10-02 to be in an RRC connected mode (RRC_CONNCTED) (10-05).

At step 10-10, the UE 10-01 may transmit a UE capability information message (UECapabilityInformation) to the base station 10-02. The message may include an indicator indicating that early measurement may be performed in an RRC idle mode or an RRC inactive mode. Additionally, the indicator may include a separate indicator indicating that early measurement may be performed on frequencies or cells mapped to a slice or a slice group.

At step 10-15, the UE 10-01 in the RRC connected mode may receive an RRC release message (RRCRelease) from the base station 10-02. The RRC release message may store a measIdleConfig containing an early measurement configuration (idle/inactive measurement configuration). The measConfig may include at least one of the following information.
measIdleCarrierListNR: A list of NR carriers to perform early measurement (idle/inactive measurement) in an RRC idle mode or RRC inactive mode (RRC_INACTIVE). Each NR carrier may include at least one of the following information. Additionally, the measIdleCarrierListNR may include information on which slice group is supported for each NR carrier. That is, one or multiple slice groups may be included in the corresponding carrier, and the measIdleCarrierListNR may include information on which cells are supported for each slice group.

| | |
|---|---|
| MeasIdleCarrierNR-r16 ::= | SEQUENCE { |

| | |
|---|---|
| carrierFreq-r16 | ARFCN-ValueNR, |
| ssbSubcarrierSpacing-r16 | SubcarrierSpacing, |
| frequencyBandList | MultiFrequencyBandListNR |

OPTIONAL, -- Need R

| | |
|---|---|
| measCellListNR-r16 | CellListNR-r16 |

OPTIONAL, - Need R

| | |
|---|---|
| reportQuantities-r16 | ENUMERATED {rsrp, rsrq, both}, |
| qualityThreshold-r16 | SEQUENCE { |
| idleRSRP-Threshold-NR-r16 | RSRP-Range |

OPTIONAL, - Need R

| | |
|---|---|
| idleRSRQ-Threshold-NR-r16 | RSRQ-Range |

OPTIONAL -- Need R
}
OPTIONAL, -- Need R

| | |
|---|---|
| ssb-MeasConfig-116 | SEQUENCE { |
| nrofSS-BlocksToAverage-r16 | INTEGER (2..maxNrofSS-BlocksToAverage) |

OPTIONAL, -- Need S
absThreshSS-BlocksConsolidation-r16 ThresholdNR
OPTIONAL, -- Need S

| | |
|---|---|
| smtc-r16 | SSB-MTC |

OPTIONAL, -- Need S

| | |
|---|---|
| ssb-ToMeasure-r16 | SSB-ToMeasure |

OPTIONAL, -- Need S

| | |
|---|---|
| deriveSSB-IndexFromCell-r16 | BOOLEAN, |
| ss-RSSI-Measurement-r16 | SS-RSSI-Measurement |

OPTIONAL --Need S
}
OPTIONAL, -- Need S

| | |
|---|---|
| beamMeasConfigIdle-r16 | BeamMeasConfigIdle-NR-r16 |

OPTIONAL, -- Need R
...
}|

measIdleCarrierListEUTRA: A list of E-UTRA carriers to perform measurement in an RRC idle mode. Each E-UTRA carrier may include at least one of the following information.

| | |
|---|---|
| MeasIdleCarrierEUTRA-r16 ::= | SEQUENCE { |

| | |
|---|---|
| carrierFreqEUTRA-r16 | ARFCN-ValueEUTRA, |
| allowedMeasBandwidth-r16 | EUTRA-AllowedMeasBandwidth, |
| measCellListEUTRA-r16 | CellListEUTRA-r16 |

OPTIONAL, -- Need R

| | |
|---|---|
| reportQuantitiesEUTRA-r16 | ENUMERATED {rsrp, rsrq, both}, |
| qualityThresholdEUTRA-r16 | SEQUENCE { |
| idleRSRP-Threshold-EUTRA-r16 | RSRP-RangeEUTRA |

OPTIONAL, -- Need R

| | |
|---|---|
| idleRSRQ-Threshold-EUTRA-r16 | RSRQ-RangeEUTRA-r16 |

```
OPTIONAL -- Need R
  }
OPTIONAL, -- Need S
  ...
}
}
```

measIdleDuration: Duration value (T331 timer value) for performing early measurement in an RRC idle mode or RRC inactive mode.
validityAreaList: A list of frequencies in which the UE requests to perform early measurement in an RRC idle mode or RRC inactive mode and/or a list of cells according to each frequency.

At step 10-17, the UE 10-01 in the RRC connected mode may apply a measIdleConfig stored in an RRCRelease message.

At step 10-20, the UE 10-01 may be switched to an RRC idle mode or RRC inactive mode.

At step 10-25, the UE 10-01 may acquire system information from the base station 10-02. The base station transmitting the RRC release message at step 10-15 and the base station transmitting system information at step 10-25 may be the same base station or different base stations. Early measurement configuration information may be stored in the system information. Specifically, early measurement configuration information may be stored in SIB4 or SIB11.
SIB11: SIB11 includes measIdleConfigSIB, and may include at least one of the following.

MeasIdleConfigSIB-r16 ::= SEQUENCE {

| | |
|---|---|
| measIdleCarrierListNR-r16 | SEQUENCE (SIZE (1..maxFreqIdle-r16)) OF MeasIdleCarrierNR-r16 |

OPTIONAL, -- Need S

| | |
|---|---|
| measIdleCarrierListEUTRA-r16 | SEQUENCE (SIZE (1..maxFreqIdle-r16)) OF MeasIdleCarrierEUTRA-r16 |

OPTIONAL, --Need S
...
}

SIB4: SIB4 may include cell reselection information related to an NR inter-frequency and NR idle/inactive measurements information, and include at least one of the following.

Additionally, which slice group(s) is (are) supported for each frequency or for each frequency and each cell for early measurements may be broadcasted in the system information (SIB4, SIB11, SIB16, or new SIB).

At step 10-30, the UE 10-01 in the RRC idle mode or RRC inactive mode may perform idle/inactive measurement. Specifically, the UE 10-01 may perform idle/inactive measurement while a T331 timer is running, and a specific UE operation is as follows.
1> perform the measurements in accordance with the following:
2> if the VarMeasIdleConfig includes the measIdleCarrierListEUTRA and the SIB1 contains idleModeMeasurementsEUTRA:
3> for each entry in measIdleCarrierListEUTRA within VarMeasIdleConfig:
4> if UE supports NE-DC between the serving carrier and the carrier frequency indicated by carrierFreqEUTRA within the corresponding entry:
5> perform measurements in the carrier frequency and bandwidth indicated by carrierFreqEUTRA and allowedMeasBandwidth within the corresponding entry;
5> if the reportQuantitiesEUTRA is set to rsrq:
6>consider RSRQ as the sorting quantity;
5> else:
6>consider RSRP as the sorting quantity;
5> if the measCellListEUTRA is included:
6>consider cells identified by each entry within the measCellListEUTRA to be applicable for idle/inactive mode measurement reporting;
5> else:
6>consider up to maxCellMeasIdle strongest identified cells, according to the sorting quantity, to be applicable for idle/inactive measurement reporting;
5> for all cells applicable for idle/inactive measurement reporting, derive measurement results for the measurement quantities indicated by reportQuantitiesEUTRA;
5> store the derived measurement results as indicated by reportQuantitiesEUTRA within the measReportIdleEUTRA in VarMeasIdleReport in decreasing order of the sorting quantity, i.e. the best cell is included first, as follows:
6> if qualityThresholdEUTRA is configured:
7> include the measurement results from the cells applicable for idle/inactive measurement reporting whose RSRP/RSRQ measurement results are above the value(s) provided in qualityThresholdEUTRA;
6> else:
7> include the measurement results from all cells applicable for idle/inactive measurement reporting;
2> if the VarMeasIdleConfig includes the measIdleCarrierListNR and the SIB1 contains idleModeMeasurementsNR:
3> for each entry in measIdleCarrierListNR within VarMeasIdleConfig that contains ssb-MeasConfig:
4> if UE supports carrier aggregation or NR-DC between serving carrier and the carrier frequency and subcarrier spacing indicated by carrierFreq and ssbSubCarrierSpacing within the corresponding entry:
5> perform measurements in the carrier frequency and subcarrier spacing indicated by carrierFreq and ssbSubCarrierSpacing within the corresponding entry;
5> if the reportQuantities is set to rsrq:
6>consider RSRQ as the cell sorting quantity;
5> else:
6>consider RSRP as the cell sorting quantity;
5> if the measCellListNR is included:
6>consider cells identified by each entry within the measCellListNR to be applicable for idle/inactive measurement reporting;
5> else:
6>consider up to maxCellMeasIdle strongest identified cells, according to the sorting quantity, to be applicable for idle/inactive measurement reporting;
5> for all cells applicable for idle/inactive measurement reporting, derive cell measurement results for the measurement quantities indicated by reportQuantities;
5> store the derived cell measurement results as indicated by reportQuantities for cells applicable for idle/inactive measurement reporting within measResultsPerCarrierListIdleNR in the measReportIdleNR in VarMeasIdleReport in decreasing order of the cell sorting quantity, i.e. the best cell is included first, as follows:
6> if quality Threshold is configured:
7> include the measurement results from the cells applicable for idle/inactive measurement reporting whose RSRP/RSRQ measurement results are above the value(s) provided in quality Threshold;
6> else:
7> include the measurement results from all cells applicable for idle/inactive measurement reporting;
5> if beamMeasConfigIdle is included in the associated entry in measIdleCarrierListNR and if UE supports idleInactiveNR-MeasBeamReport for the FR of the carrier frequency indicated by carrierFreq within the associated entry, for each cell in the measurement results:
6>derive beam measurements based on SS/PBCH block for each measurement quantity indicated in reportQuantityRS-Indexes, as described in TS 38.215 [9];
6> if the reportQuantityRS-Indexes is set to rsrq:
7>consider RSRQ as the beam sorting quantity;
6> else:
7>consider RSRP as the beam sorting quantity;
6> set resultsSSB-Indexes to include up to maxNrofRS-IndexesToReport SS/PBCH block indexes in order of decreasing beam sorting quantity as follows:
7> include the index associated to the best beam for the sorting quantity and if absThreshSS-BlocksConsolidation is included, the remaining beams whose sorting quantity is above absThreshSS-BlocksConsolidation;
6> if the includeBeamMeasurements is set to true:
7> include the beam measurement results as indicated by reportQuantityRS-Indexes;
2> if, as a result of the procedure in this subclause, the UE performs measurements in one or more carrier frequency indicated by measIdleCarrierListNR or measIdleCarrierListEUTRA:
3> store the cell measurement results for RSRP and RSRQ for the serving cell within measResultServingCell in the measReportIdleNR in VarMeasIdleReport.
3> if the VarMeasIdleConfig includes the measIdleCarrierListNR and it contains an entry with carrierFreq set to the value of the serving frequency:
4> if beamMeasConfigIdle is included in that entry, and if the UE supports idleInactiveNR-MeasBeamReport for the FR of the serving cell:
5>derive beam measurements based on SS/PBCH block for each measurement quantity indicated in reportQuantityRS-Indexes, as described in TS 38.215 [9];
5> if the reportQuantityRS-Indexes is set to rsrq:
6>consider RSRQ as the beam sorting quantity;
5> else:
6>consider RSRP as the beam sorting quantity;
5> set resultsSSB-Indexes to include up to maxNrofRS-IndexesToReport SS/PBCH block indexes in order of decreasing beam sorting quantity as follows:
6> include the index associated to the best beam for the sorting quantity and if absThreshSS-BlocksConsolidation is included in SIB2 of serving cell, the remaining beams whose sorting quantity is above absThreshSS-BlocksConsolidation;
5> if the includeBeamMeasurements is set to true:
6> include the beam measurement it results as indicated by reportQuantityRS-Indexes;

For reference, the UE 10-01 may also store slice group information when storing measurement results for each cell or frequency. Alternatively, in the case that there are more measurement configurations than those that may be reported by the UE 10-01 among measurement configurations for early measurement, the UE 10-01 may measure and store frequencies that support an intended slice(s) or slice group(s) with a priority.

At step 10-35, the UE 10-01 in the RRC idle mode or RRC inactive mode may perform an RRC connection establishment procedure or an RRC connection resume procedure with the base station 10-02 to be switched to the RRC connected mode. The UE 10-01 may transmit an RRC connection establishment completion message or an RRC resume completion message to the base station 10-02. The completion message may include an indicator that there is an early measurement result.

At step 10-40, the base station 10-02 may transmit a UE information request message (UEInformationRequest) to the UE 10-01. The message may include an indicator to report early measurement information of the UE.

At step 10-45, the UE 10-01 may transmit a UE information response message (UEInformationResponse) to the base station 10-02. The message may include early measurements.

At step 10-50, the base station 10-02 may transmit an RRC reconfiguration message (RRCReconfiguration) to the UE 10-01. The base station 10-02 may quickly configure carrier aggregation and/or dual connectivity to the UE through the RRC reconfiguration message based on the information received at step 10-45.

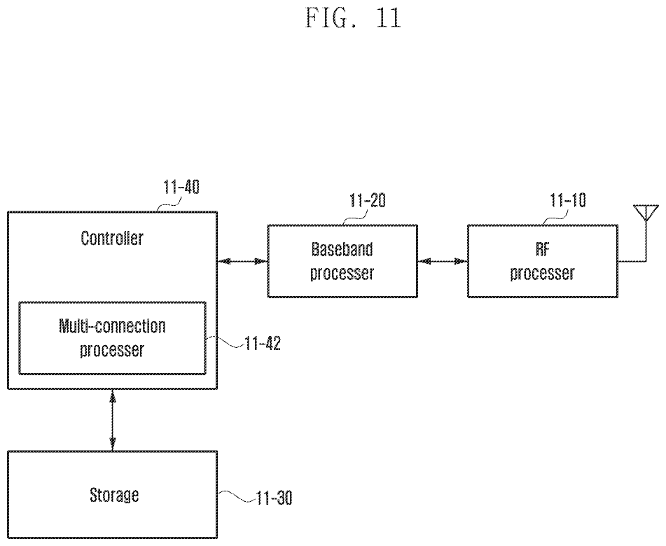

FIG. 11 is a block diagram illustrating a constitution of a UE according to an embodiment of the disclosure.

With reference to FIG. 11, the UE includes a radio frequency (RF) processer 11-10, a baseband processer 11-20, a storage 11-30, and a controller 11-40. The controller 1140 may further include a multi-connection processer 11-42.

The RF processer 11-10 performs a function for transmitting and receiving signals through a wireless channel, such as band conversion and amplification of signals. That is, the RF processer 11-10 up-converts a baseband signal provided from the baseband processer 11-20 into an RF band signal, transmits the RF band signal through an antenna, and down-converts the RF band signal received through the antenna into a baseband signal. For example, the RF processor 11-10 may include a transmission filter, a reception filter, an amplifier, a mixer, an oscillator, a digital to analog converter (DAC), an analog to digital converter (ADC), and the like. In the above drawing, only one antenna is illustrated, but the UE may have multiple antennas. Further, the RF processer 11-10 may include a plurality of RF chains. Furthermore, the RF processor 11-10 may perform beamforming. For beamforming, the RF processor 11-10 may adjust a phase and magnitude of each of signals transmitted and received through a plurality of antennas or antenna elements. Further, the RF processor may perform multiple-input and multiple-output (MIMO), and receive several layers when performing the MIMO operation.

The baseband processer 11-20 performs a conversion function between a baseband signal and a bit string according to the physical layer standard of the system. For example, when transmitting data, the baseband processor 11-20 encodes and modulates a transmission bit string to generate complex symbols. Further, when receiving data, the baseband processer 11-20 demodulates and decodes the baseband signal provided from the RF processer 11-10 to restore the received bit string. For example, in the case of following an orthogonal frequency division multiplexing (OFDM) scheme, when transmitting data, the baseband processor 11-20 encodes and modulates a transmission bit string to generate complex symbols, maps the complex symbols to subcarriers, and then forms OFDM symbols through inverse fast Fourier transform (IFFT) operation and cyclic prefix (CP) insertion. Further, when receiving data, the baseband processer 11-20 divides the baseband signal provided from the RF processer 11-10 into OFDM symbol units, restores signals mapped to subcarriers through fast Fourier transform (FFT), and then restores the received bit string through demodulation and decoding.

The baseband processer 11-20 and the RF processer 11-10 transmit and receive signals, as described above. Accordingly, the baseband processer 11-20 and the RF processer 11-10 may be referred to as a transmitter, a receiver, a transceiver, or a communication unit. Furthermore, at least one of the baseband processer 11-20 or the RF processer 11-10 may include a plurality of communication modules in order to support a plurality of different radio access technologies. Further, at least one of the baseband processor 11-20 or the RF processor 11-10 may include different communication modules in order to process signals of different frequency bands. For example, different radio access technologies may include a wireless LAN (e.g., IEEE 802.11), a cellular network (e.g., LTE), and the like. Further, the different frequency bands may include a super high frequency (SHF) (e.g., 2.NRHz, NRhz) band and a millimeter wave (e.g., 60 GHz) band.

The storage 11-30 stores data such as a basic program, an application program, and configuration information for operation of the UE. In particular, the storage 11-30 may store information related to a second access node performing wireless communication using second wireless access technology. The storage 11-30 provides the stored data according to the request of the controller 11-40.

The controller 11-40 controls overall operations of the UE. For example, the controller 11-40 transmits and receives signals through the baseband processor 11-20 and the RF processor 11-10. Further, the controller 11-40 writes and reads data in the storage 11-30. To this end, the controller 11-40 may include at least one processor. For example, the controller 11-40 may include a communication processor (CP) that controls communication and an application processor (AP) that controls upper layers such as application programs.

For example, the controller 11-40 may control to store measurement information acquired through slice-based cell reselection in a radio resource control (RRC) idle state or an RRC inactive state, to transmit measurement information acquired through the slice-based cell reselection to the base station after the UE is switched to an RRC connected state, and to receive, from the base station, information for configuring a cell supporting a slice for the UE based on measurement information acquired through the slice-based cell reselection.

Further, the controller 11-40 may control to receive system information including a capability to retrieve measurement information acquired through slice-based cell reselection from the base station, and to transmit an indicator indicating that measurement information acquired through the slice-based cell reselection is stored to the base station.

Further, the controller 11-40 may control to receive a UE information request message instructing reporting of measurement information acquired through the slice-based cell reselection from the base station, and to include measurement information acquired through the slice-based cell reselection in a UE information response message to transmit the UE information response message to the base station.

Further, the controller 11-40 may control to transmit an indicator indicating that reporting of measurement information acquired through the slice-based cell reselection is supported, and to receive an RRC release message for switching the UE to the RRC idle state or the RRC inactive state. The RRC release message may include an indicator indicating to store measurement information acquired through the slice-based cell reselection.

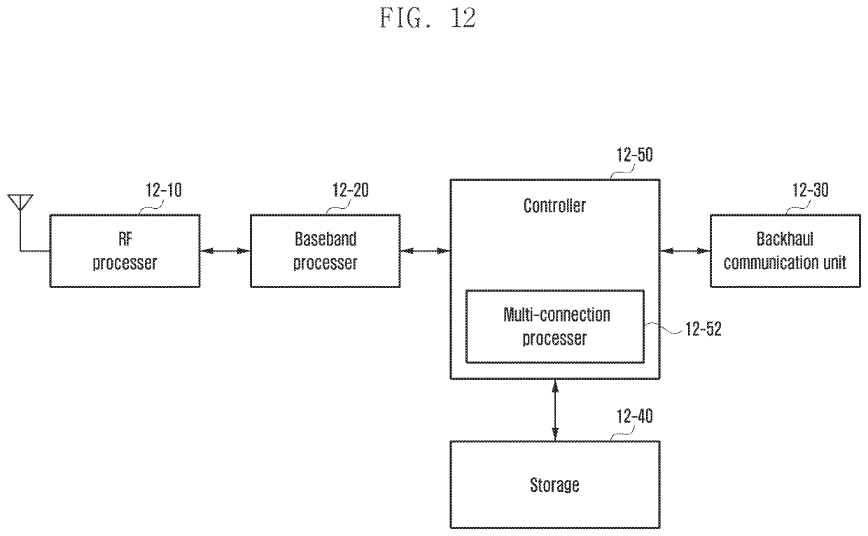

FIG. 12 is a block diagram illustrating a constitution of a base station according to an embodiment of the disclosure.

With reference to FIG. 12, the base station includes an RF processer 12-10, a baseband processer 12-20, a backhaul communication unit 12-30, a storage 12-40, and a controller 12-50. The controller 12-50 may further include a multi-connection processer 12-52.

The RF processer 12-10 performs a function for transmitting and receiving a signal through a wireless channel, such as band conversion and amplification of a signal. That is, the RF processor 12-10 up-converts a baseband signal provided from the baseband processor 12-20 into an RF band signal, transmits the RF band signal through an antenna, and down-converts the RF band signal received through the antenna into a baseband signal. For example, the RF processer 12-10 may include a transmission filter, a reception filter, an amplifier, a mixer, an oscillator, a DAC, an ADC, and the like. In the above drawing, although only one antenna is illustrated, a first access node may include a plurality of antennas. Further, the RF processer 12-10 may include a plurality of RF chains. Furthermore, the RF processer 12-10 may perform beamforming. For the beamforming, the RF processer 12-10 may adjust a phase and magnitude of each of signals transmitted and received through a plurality of antennas or antenna elements. The RF processer may transmit one or more layers to perform a downlink MIMO operation.

The baseband processer 12-20 performs a conversion function between a baseband signal and a bit stream according to the physical layer standard of first radio access technology. For example, when transmitting data, the baseband processer 12-20 encodes and modulates a transmission bit stream to generate complex symbols. Further, when receiving data, the baseband processer 12-20 demodulates and decodes the baseband signal provided from the RF processer 12-10 to restore a received bit stream. For example, in the case of following the OFDM scheme, when transmitting data, the baseband processer 12-20 encodes and modulates a transmission bit stream to generate complex symbols, maps the complex symbols to subcarriers, and then forms OFDM symbols through IFFT operation and CP insertion. Further, when receiving data, the baseband processer 12-20 divides the baseband signal provided from the RF processer 12-10 into OFDM symbol units, restores signals mapped to subcarriers through an FFT operation, and then restores the received bit stream through demodulation and decoding. The baseband processer 12-20 and the RF processer 12-10 transmit and receive signals, as described above. Accordingly, the baseband processer 12-20 and the RF processer 12-10 may be referred to as a transmitter, a receiver, a transceiver, a communication unit, or a RF unit.

The backhaul communication unit 12-30 provides an interface for communicating with other nodes in the network. For example, the backhaul communication unit 12-30 converts a bit string transmitted from a main base station to another node, for example, an auxiliary base station and a core network into a physical signal, and converts a physical signal received from the other node to a bit string.

The storage 12-40 stores data such as a basic program, an application program, and configuration information for an operation of the main base station. In particular, the storage 12-40 may store information on a bearer allocated to an accessed UE, a measurement result reported from the accessed UE, and the like. Further, the storage 12-40 may store information to be a criterion for determining whether to provide or stop multiple connections to the UE. The storage 12-40 provides stored data according to a request of the controller 12-50.

The controller 12-50 controls overall operations of the main base station. For example, the controller 12-50 transmits and receives signals through the baseband processer 12-20 and the RF processer 12-10 or through the backhaul communication unit 12-30. Further, the controller 12-50 writes and reads data in the storage 12-40. To this end, the controller 12-50 may include at least one processor.

The controller 12-50 may control to broadcast system information including a capability for retrieving measurement information acquired through slice-based cell reselection, to receive measurement information from the UE converted from a radio resource control (RRC) idle state or an RRC inactive state to an RRC connected state through the slice-based cell reselection, and to transmit information for configuring a cell supporting a slice for the UE to the UE based on measurement information acquired through the slice-based cell reselection.

The controller 12-50 may control to receive an indicator indicating that measurement information acquired through the slice-based cell reselection is stored from the UE. Further, the controller 12-50 may control to transmit a UE information request message instructing reporting of measurement information acquired through the slice-based cell reselection to the UE, and to receive a UE information response message including measurement information acquired through the slice-based cell reselection from the UE.

Methods according to the embodiments described in the claims or specifications of the disclosure may be implemented in the form of hardware, software, or a combination of hardware and software.

In the case of being implemented in software, a computer readable storage medium storing one or more programs (software modules) may be provided. One or more programs stored in the computer readable storage medium are configured for execution by one or more processors in an electronic device. The one or more programs include instructions for causing the electronic device to execute methods according to embodiments described in claims or specification of the disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs), another form of optical storage device, or a magnetic cassette. Alternatively, the programs may be stored in a memory composed of a combination of some or all thereof. Further, each constitution memory may be included in the plural.

Further, the program may be stored in an attachable storage device that may access through a communication network such as the Internet, Intranet, local area network (LAN), wide LAN (WLAN), or storage area network (SAN), or a communication network composed of a combination thereof. Such a storage device may access a device implementing an embodiment of the disclosure through an external port. Further, a separate storage device on the communication network may access the device implementing the embodiment of the disclosure.

In the above-described specific embodiments of the disclosure, components included in the disclosure have been expressed in the singular or the plural according to the presented specific embodiments. However, the singular or plural expression is appropriately selected for a presented situation for convenience of description, and the disclosure is not limited to the singular or plural components, and even if a component is represented in the plural, it may be composed of the singular, or even if a component is represented in the singular, it may be composed of the plural.

Embodiments of the disclosure disclosed in this specification and drawings merely present specific examples in order to easily describe the technical contents of the disclosure and help the understanding of the disclosure, and they are not intended to limit the scope of the disclosure. That is, it will be apparent to those of ordinary skill in the art to which the disclosure pertains that other modifications based on the technical spirit of the disclosure may be implemented. Further, each of the above embodiments may be operated in combination with each other, as needed. For example, parts of an embodiment and another embodiment of the disclosure may be combined to operate the base station and the UE. Further, the embodiments of the disclosure may be applied to other communication systems, and other modifications based on the technical idea of the embodiments may also be implemented.

1. A method performed by a terminal in a wireless communication system, the method comprising:
storing measurement information acquired through slice-based cell reselection in a radio resource control (RRC) idle state or an RRC inactive state;
transmitting, to a base station, measurement information acquired through the slice-based cell reselection after the terminal is switched to an RRC connected state; and
receiving, from the base station, information for configuring a cell supporting a slice for the terminal based on measurement information acquired through the slice-based cell reselection.

2. The method of claim 1, further comprising:
receiving, from the base station, system information including a capability to retrieve measurement information acquired through the slice-based cell reselection; and
transmitting, to the base station, an indicator indicating that measurement information acquired through the slice-based cell reselection is stored.

3. The method of claim 2, further comprising:
receiving a terminal information request message instructing reporting of measurement information acquired through the slice-based cell reselection from the base station,
wherein measurement information acquired through the slice-based cell reselection is included in a terminal information response message and is transmitted to the base station.

4. The method of claim 1, further comprising:
transmitting an indicator indicating that reporting of measurement information acquired through the slice-based cell reselection is supported; and
receiving an RRC release message for switching the terminal to the RRC idle state or the RRC inactive state,
wherein the RRC release message comprises an indicator indicating to store measurement information acquired through the slice-based cell reselection.

5. A method performed by a base station in a wireless communication system, the method comprising:
broadcasting system information including a capability to retrieve measurement information acquired through slice-based cell reselection;
receiving measurement information through the slice-based cell reselection from a terminal converted from a radio resource control (RRC) idle state or an RRC inactive state to an RRC connected state; and
transmitting, to the terminal, information for configuring a cell supporting a slice for the terminal based on measurement information acquired through the slice-based cell reselection.

6. The method of claim 5, further comprising:
receiving, from the terminal, an indicator indicating that measurement information acquired through the slice-based cell reselection is stored.

7. The method of claim 6, further comprising:
transmitting, to the terminal, a terminal information request message instructing reporting of measurement information acquired through the slice-based cell reselection,
wherein measurement information acquired through the slice-based cell reselection is included in a terminal information response message and is received from the terminal.

8. The method of claim 6, further comprising:
receiving an RRC resume request message from the terminal; and
transmitting, to the terminal, an RRC resume message including an indicator indicating reporting of measurement information acquired through the slice-based cell reselection,
wherein measurement information acquired through the slice-based cell reselection is included in an RRC resume completion message and is received from the terminal.

9. A terminal of a wireless communication system, the terminal comprising:
a transceiver; and
a controller,
wherein the controller is configured to control to:
store measurement information acquired through slice-based cell reselection in a radio resource control (RRC) idle state or an RRC inactive state,
transmit, to a base station, measurement information acquired through the slice-based cell reselection after the terminal is switched to an RRC connected state, and
receive, from the base station, information for configuring a cell supporting a slice for the terminal based on measurement information acquired through the slice-based cell reselection.

10. The terminal of claim 9, wherein the controller is configured to control to:
receive, from the base station, system information including a capability to retrieve measurement information acquired through the slice-based cell reselection; and
transmit, to the base station, an indicator indicating that measurement information acquired through slice-based cell reselection is stored.

11. The terminal of claim 10, wherein the controller is configured to:
control to receive a terminal information request message instructing reporting of measurement information acquired through the slice-based cell reselection from the base station; and
measurement information acquired through the slice-based cell reselection is included in a terminal information response message and is transmitted to the base station.

12. The terminal of claim 9,
wherein the controller is configured to control to:
transmit an indicator indicating that reporting of measurement information acquired through the slice-based cell reselection is supported, and
receive an RRC release message for switching the terminal to the RRC idle state or the RRC inactive state, and
wherein the RRC release message comprises an indicator indicating to store measurement information acquired through the slice-based cell reselection.

13. A base station of a wireless communication system, the base station comprising:
a transceiver; and
a controller,
wherein the controller is configured to control to:
broadcast system information including a capability to retrieve measurement information acquired through slice-based cell reselection,
receive measurement information through the slice-based cell reselection from a terminal converted from a radio resource control (RRC) idle state or an RRC inactive state to an RRC connected state, and
transmit, to the terminal, information for configuring a cell supporting a slice for the terminal based on measurement information acquired through the slice-based cell reselection.

14. The base station of claim 13, wherein the controller is configured to control to receive, from the terminal, an indicator indicating that measurement information acquired through the slice-based cell reselection is stored.

15. The base station of claim 13,
wherein the controller is configured to control to transmit a terminal information request message instructing reporting of measurement information acquired through the slice-based cell reselection to the terminal, and
measurement information acquired through the slice-based cell reselection is included in a terminal information response message and is received from the terminal.
